(19) United States
(12) Patent Application Publication
(10) Pub. No.: US 2017/0147946 A1
(43) Pub. Date: May 25, 2017

(54) METHOD AND APPARATUS FOR MACHINE LEARNING

(71) Applicant: FUJITSU LIMITED, Kawasaki-shi (JP)

(72) Inventor: YUHEI UMEDA, Kawasaki (JP)

(73) Assignee: FUJITSU LIMITED, Kawasaki-shi (JP)

(21) Appl. No.: 15/334,405

(22) Filed: Oct. 26, 2016

(30) Foreign Application Priority Data
Nov. 25, 2015 (JP) 2015-229626

(51) Int. Cl. G06N 99/00; G06N 5/04

(52) U.S. Cl. CPC G06N 99/005; G06N 5/046

(57) ABSTRACT

A machine learning method related to these embodiments includes: first generating a pseudo attractor from each of plural series data sets, the pseudo attractor being a set of points in N-dimensional space, each of the points including N values sampled at an equal interval; second generating a series data set of Betti numbers from each of plural pseudo attractors generated in the first generating, each of the Betti numbers being a number of holes for a radius of a N-dimensional sphere in the N-dimensional space; and performing machine learning for each of plural series data sets of Betti numbers generated in the second generating, the series data set of Betti numbers being used as input in the machine learning.

### CROSS-REFERENCE TO RELATED APPLICATIONS

This application is based upon and claims the benefit of priority of the prior Japanese Patent Application No. 2015-229626, filed on Nov. 25, 2015, the entire contents of which are incorporated herein by reference.

### FIELD

This invention relates to machine learning.

### BACKGROUND

Machine learning is performed also on series data that continuously changes as time elapses.

As a method for performing machine learning on series data, there is a known method in which a feature value that is extracted from series data is used as input. The feature value that is used is, for example, (a) a statistical amount such as an average value, a maximum value and a minimum value, (b) a moment of a statistical amount such as a dispersion and kurtosis, and (c) data of frequency that is calculated using Fourier transformation and the like.

However, a rule of change (in other words, an original feature) in series data does not always appear in a waveform. For example, in the case of a chaotic time series, even when rules of change are the same, completely different waveforms appear due to a butterfly effect. Therefore, the feature value extracted from the actual series data does not reflect the rule of change, and there is a case where the series data is not able to be classified according to the rule of change.

As a method for analyzing in chaos theory, there is a method for artificially generating an attractor which is a set of points in N-dimensional space from series data, each of which includes N (N is an embedding dimension; typically, N=3 or 4) values sampled at an equal interval. Hereafter, an attractor that is generated in this way will be referred to as a pseudo attractor.

Non-Patent Document 1: David Ruelle, “WHAT IS . . . a Strange Attractor?”, Notices of the American Mathematical Society, August 2006, Vol. 53, No.7, pp.764-765

Non-Patent Document 2: J. Jimenez, J. A. Moreno, and G. J. Ruggeri, “Forecasting on chaotic time series: A local optimal linear-reconstruction method”, Physical Review A, Mar. 15, 1992, Vol.45, No.6, pp.3553-3558

Non-Patent Document 3: J. Doyne Farmer and John J. Sidorowich, “Predicting Chaotic Time Series”, Physical Review Letters, Aug. 24, 1987, Vol.59, No.8, pp.845-848

### SUMMARY

By using the method described above, it is possible to express a rule of change in series data according to a mutual relationship among points in N-dimensional space, however, coordinates themselves of each point do not have a meaning. Therefore, even though machine learning is performed on a set of points in N-dimensional space by using coordinates of each point, the series data is classified independently of its original feature.

Moreover, there is a case where not only white noise but also noise other than white noise is included in series data and an effect of that noise may also remain in a pseudo attractor that is generated from the series data. Therefore, when machine learning is performed based on a mutual relationship among points in N-dimensional space, accuracy of classification will decrease due to that noise. Particularly, when time resolution with respect to change in series data is not sufficient, the effect of that noise remarkably appears.

In other words, there is no technique to classify series data by using a pseudo attractor that was generated from the series data.

A machine learning method related to this invention includes: first generating a pseudo attractor from each of plural series data sets, the pseudo attractor being a set of points in N-dimensional space, each of the points including N values sampled at an equal interval; second generating a series data set of Betti numbers from each of plural pseudo attractors generated in the first generating by calculation of persistent homology, each of the Betti numbers being a number of holes for a radius of a N-dimensional sphere in the N-dimensional space; and performing machine learning for each of plural series data sets of Betti numbers generated in the second generating, the series data set of Betti numbers being used as input in the machine learning.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram of an information processing apparatus in a first embodiment;

FIG. 2 is a diagram depicting an example of series data that is stored in a first series data storage unit;

FIG. 3 is a diagram depicting a processing flow of the first embodiment;

FIG. 4 is a diagram depicting an example of time series data;

FIGS. 5A to 5F are diagrams for explaining homology;

FIGS. 6A to 6D are diagrams for explaining persistent homology;

FIG. 7 is a diagram depicting an example of a persistence diagram;

FIG. 8 is a diagram depicting an example of a barcode diagram;

FIG. 9 is a diagram depicting an example of data for generating persistence diagram and barcode diagram;

FIGS. 10A and 10B are diagrams for explaining an effect of noise;

FIGS. 11A and 11B are diagrams for explaining an effect of noise;

FIGS. 12A and 12B are diagrams for explaining an effect of noise;

FIGS. 13A and 13B are diagrams for explaining an effect of noise;

FIGS. 14A and 14B are diagrams for explaining an effect of noise;

FIG. 15 is a diagram for explaining a relationship between barcode data and generated series data;

FIGS. 16A and 16B are diagrams depicting an example of a persistent interval;

FIG. 17 is a diagram depicting an example of a pseudo attractor;

FIG. 18 is a diagram depicting an example of a pseudo attractor;

FIGS. 19A and 19B are diagrams depicting an example of barcode data;

FIGS. 20A and 20B are diagrams depicting an example of barcode data;

FIGS. 21A and 21B are diagrams depicting an example of barcode data whose noise was removed;

FIGS. 22A and 22B are diagrams depicting an example of barcode data whose noise was removed;

FIGS. 23A to 23D are diagrams depicting a Betti time series for 0-dimensional holes;

FIGS. 24A to 24D are diagrams depicting a Betti time series for 1-dimensional holes;

FIG. 25 is a diagram depicting an example of three graphs of series data that represents measured values of a gyro sensor worn on a right arm of a person in moving or exercising;

FIG. 26 is a diagram depicting a graph of series data for an elevator A;

FIG. 27 is a diagram depicting a graph of series data for an elevator B;

FIG. 28 is a diagram depicting a graph of series data for a running machine;

FIG. 29 is a diagram depicting a pseudo attractor for the elevator A;

FIG. 30 is a diagram depicting a pseudo attractor for the elevator B;

FIG. 31 is a diagram depicting a pseudo attractor for the running machine;

FIGS. 32A and 32B are diagrams depicting barcode data for the elevator A;

FIGS. 33A and 33B are diagrams depicting barcode data for the elevator B;

FIGS. 34A and 34B are diagrams depicting barcode data for the running machine;

FIGS. 35A and 35B are diagrams depicting barcode data for the elevator A when deleting noise;

FIGS. 36A and 36B are diagrams depicting barcode data for the elevator B when deleting noise;

FIGS. 37A and 37B are diagrams depicting barcode data for the running machine when deleting noise;

FIG. 38 is a diagram depicting a Betti time series for the elevator A;

FIG. 39 is a diagram depicting a Betti time series for the elevator B;

FIG. 40 is a diagram depicting a Betti time series for the running machine;

FIG. 41 is a diagram depicting a state in which three Betti time series are superimposed;

FIG. 42 is a diagram depicting an example of series data;

FIG. 43 is a diagram depicting an example of a pseudo attractor;

FIG. 44 is a diagram depicting an example of a Betti time series;

FIG. 45 is a diagram depicting a functional block diagram of the information processing apparatus of a second embodiment;

FIG. 46 is a diagram depicting a processing flow of the second embodiment;

FIG. 47 is a diagram depicting series data with additional data;

FIG. 48 is a diagram depicting series data with additional data;

FIG. 49 is a diagram for explaining chaos;

FIG. 50 is a diagram for explaining chaos;

FIG. 51 is a diagram for explaining chaos;

FIG. 52 is a diagram for explaining a feature value; and

FIG. 53 is a functional block diagram of a computer.

### DESCRIPTION OF EMBODIMENTS

### Embodiment 1

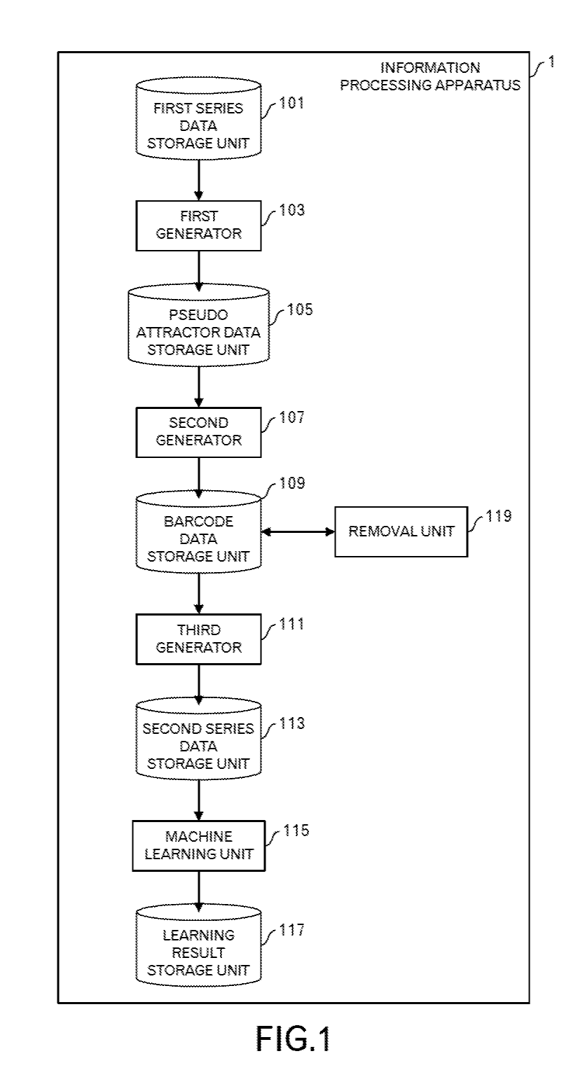

FIG. 1 is a functional block diagram of an information processing apparatus 1 of a first embodiment. The information processing apparatus 1 has a first series data storage unit 101, a first generator 103, a pseudo attractor data storage unit 105, a second generator 107, a barcode data storage unit 109, a third generator 111, a second series data storage unit 113, a machine learning unit 115, a learning result storage unit 117, and a removal unit 119.

The first generator 103 generates a pseudo attractor from series data that is stored in the first series data storage unit 101, and stores the generated pseudo attractor in the pseudo attractor data storage unit 105. The second generator 107 generates, for each dimension of elements (in other words, holes) of a persistent homology group, barcode data from the pseudo attractor that is stored in the pseudo attractor data storage unit 105, and stores the generated barcode data in the barcode data storage unit 109. The removal unit 119 deletes data related to noise from the data stored in the barcode data storage unit 109. The third generator 111 generates series data from the barcode data that is stored in the barcode data storage unit 109, and stores the generated series data in the second series data storage unit 113. The machine learning unit 115 executes machine learning in which the series data that is stored in the second series data storage unit 113 is used as input, and stores the machine learning result (for example, classification result) in the learning result storage unit 117.

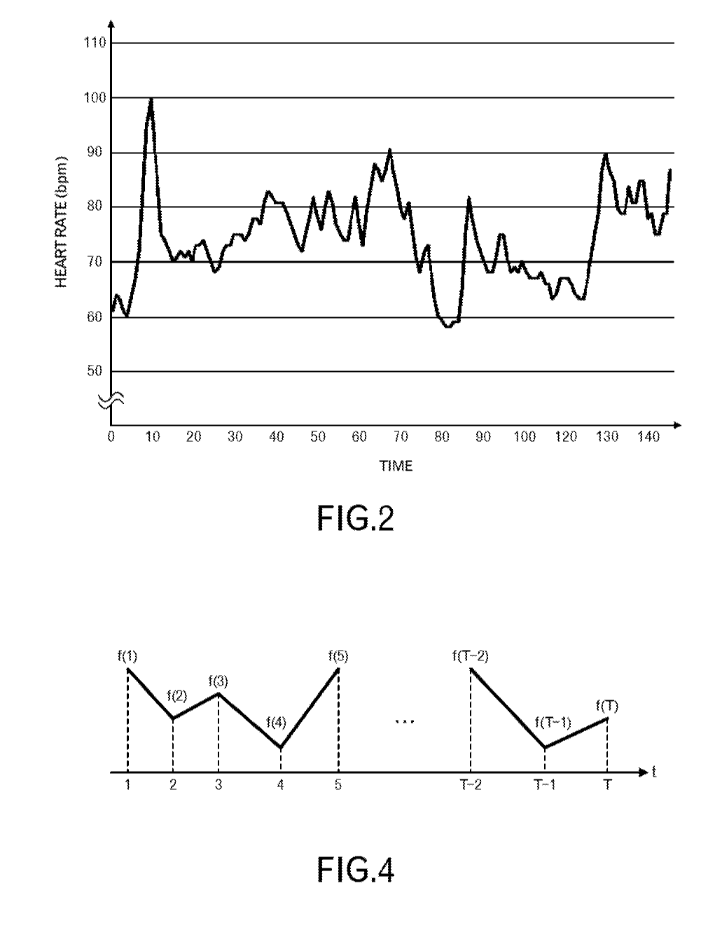

FIG. 2 is a diagram depicting an example of series data that is stored in the first series data storage unit 101. The series data in FIG. 2 is time series data that indicates change in heart rate, where the vertical axis represents a heart rate (beats per minute) and the horizontal axis represents time.

Here, time series data of a heart rate is exemplified as series data, however, the series data is not limited to this kind of time series data. For example, the series data may also be biological data other than heart rate data (time series data of brain waves, pulse, body temperature and the like), wearable sensor data (time series data of a gyro sensor, acceleration sensor, geomagnetic sensor and the like), financial data (time series data of interest, commodity prices, balance of international payments, stock prices and the like), natural environment data (time series data of temperature, humidity, carbon dioxide concentration and the like), social data (data of labor statistics, population statistics and the like). However, series data that is the target of this embodiment is data that changes according to at least the following rule.

x(i)=f(x(i−1), . . . , x(i−2),x(i−N))

For example, irregular time series data or data related to artificial movement such as tracks of handwritten characters and the like is not a target of this embodiment.

Machine learning of this embodiment may be supervised learning or unsupervised learning. In the case of supervised learning, series data that is stored in the first series data storage unit 101 is labeled series data, and parameters of calculation processing are adjusted based on a comparison of output results of machine learning and the label. The label is called teacher data. Supervised learning and unsupervised learning are well-known techniques, and a detailed explanation is omitted here.

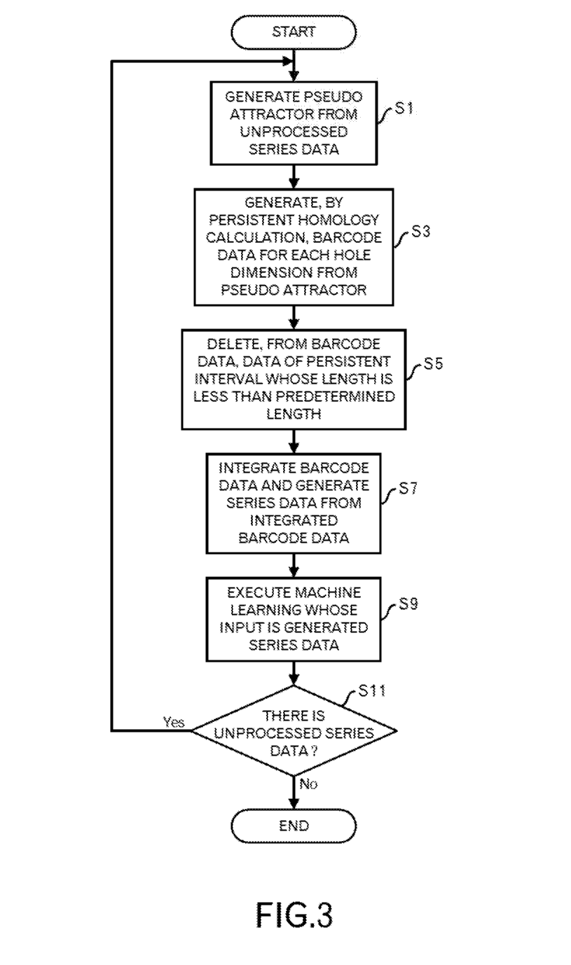

Next, operation of the information processing apparatus 1 of the first embodiment will be explained using FIG. 3 to FIG. 41.

First, the first generator 103 of the information processing apparatus 1 reads out unprocessed series data that is stored in the first series data storage unit 101. When there are plural sets of unprocessed series data stored in the first series data storage unit 101, one set of unprocessed series data is read out. Then, the first generator 103 generates a pseudo attractor from the read out series data according to Takens' embedding theorem (FIG. 3, step S1), and stores the generated pseudo attractor in the pseudo attractor data storage unit 105. Strictly speaking, a set having a finite number of points, which is generated in step S1, is not an “attractor”. And the set of points, which is generated in step S1, is referred to as a “pseudo attractor” in this description.

The generation of a pseudo attractor will be explained using FIG. 4. For example, assume that series data as illustrated in FIG. 4, which is represented by function f(t) (t expresses time). As actual values, f(1), f(2), f(3), . . . , f(T) are given. A pseudo attractor in this embodiment is a set of points in N-dimensional space, each of which includes N values that were extracted from the series data for each delay time τ (τ≧1). Here, N represents an embedding dimension, and typically N=3 or 4. For example, when N=3 and τ=1, the following pseudo attractor that includes (T−2) points is generated.

$$\{ \begin{matrix}( f ( 1 ) , f ( 2 ) , f ( 3 ) ) , ( f ( 2 ) , f ( 3 ) , f ( 4 ) ) , ( f ( 3 ) , f ( 4 ) , f ( 5 ) ) , … , \\ ( f ( T - 2 ) , f ( T - 1 ) , f ( T ) )\end{matrix} \}$$

Here, τ=1 and thus elements are extracted alternately. When τ=2, for example, a pseudo attractor that includes points (f(1), f(3), f(5)), point (f(2), f(4), f(6)), . . . is generated.

In the generation of a pseudo attractor, an effect of differences in appearance due to the butterfly effect and the like is removed, and a rule of change of original series data is reflected in the pseudo attractor. A similarity relationship among pseudo attractors is equivalent to a similarity relationship among rules. Therefore, that a certain pseudo attractor is similar to a different pseudo attractor means that rules of change in original series data are similar. Pseudo attractors that are similar to each other are generated from series data for which rules of change are the same but phenomena (appearance) are different. Pseudo attractors that are different are generated from series data for which rules of change are different but phenomena are similar.

Moreover, in the case of using series data as direct input of machine learning, starting positions must be adequately aligned.

However, by using pseudo attractors, there is no such limitation.

Returning to the explanation of FIG. 3, the second generator 107 reads out the pseudo attractor that was generated in step S1 from the pseudo attractor data storage unit 105. Then, the second generator 107 generates barcode data from the pseudo attractor using calculation of a persistent homology for each dimension of holes (hereafter, referred to as hole dimension) (step S3). The second generator 107 stores the generated barcode data in the barcode data storage unit 109.

Here, persistent homology will be explained. First, “homology” is a method for expressing features of an object by the number of holes in m (m≧0) dimensions. A “hole” referred to here is an element in a homology group, and a 0-dimensional hole is a cluster, a 1-dimensional hole is a hole (tunnel), a 2-dimensional hole is a void. The number of holes of each dimension is called a Betti number.

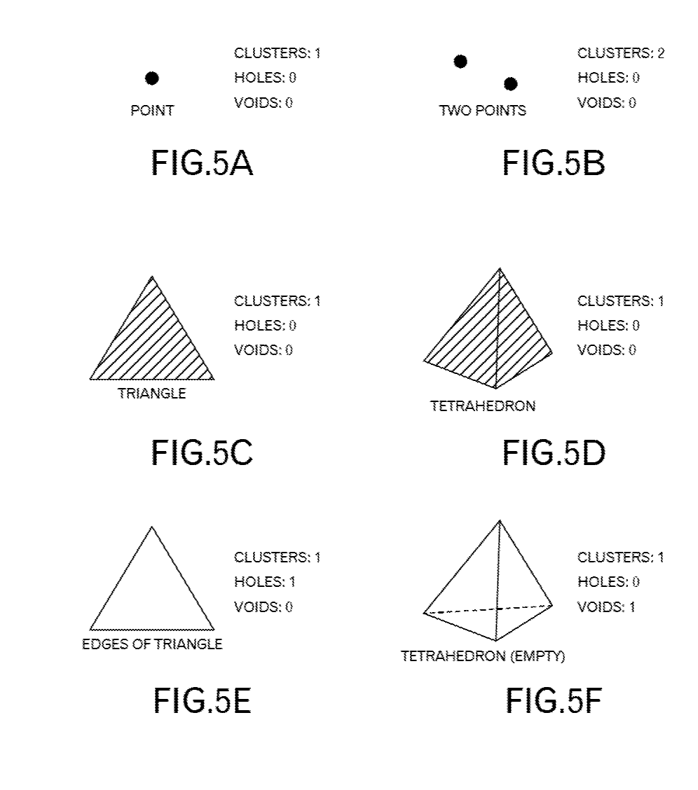

Homology will be explained in more detail using FIGS. 5A to 5F. In the case of FIG. 5A, the object is one point. In this case, the number of clusters is one, the number of holes is 0, and the number of voids is 0. In the case of FIG. 5B, the object is two points. In this case, the number of clusters is 2, the number of holes is 0 and the number of voids is 0. In the case of FIG. 5C, the object is a triangle having contents. In this case, the number of clusters is 1, the number of holes is 0 and the number of voids is 0. In the case of FIG. 5D, the object is a tetrahedron having contents. In this case, the number of clusters is 1, the number of holes is 0 and the number of voids is 0. In the case of FIG. 5E, the object is the edges of a triangle and has no contents. In this case, the number of clusters is 1, the number of holes is 1 and the number of voids is 0. In the case of FIG. 5F, the object is an empty tetrahedron. In this case, the number of clusters is 1, the number of holes is 0 and the number of voids is 1.

Here, “persistent homology” is a method for characterizing transition of m-dimensional holes in an object (here, a set of points), and it is possible to find features related to arrangement of points by using persistent homology. In this method, each point in an object is gradually made to inflate into a sphere, and in that process, a time at which each hole is born (expressed by a radius of a sphere at birth) and a time at which each hole dies (expressed by a radius of a sphere at death) are identified.

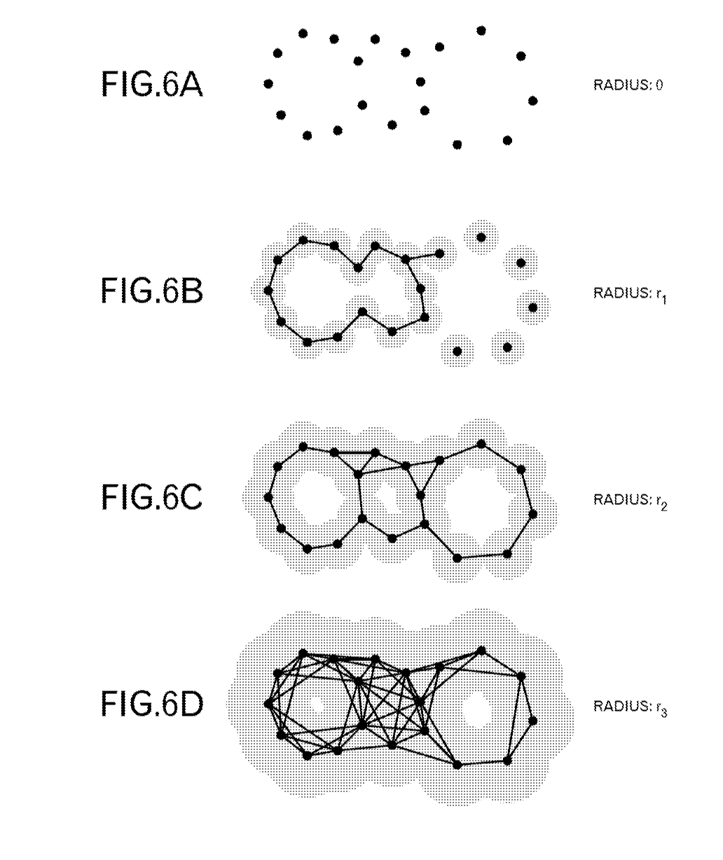

Persistent homology will be explained in more detail using FIGS. 6A to 6D. Here, when two spheres come in contact, centers of two spheres are connected by a line segment, and when three spheres come in contact, centers of the three spheres are connected by line segments. Assume that only clusters and holes are considered. In the case of FIG. 6A (radius r=0), only clusters are born, and holes are not born. In the case in FIG. 6B (radius r=r₁), a hole is born, and some of clusters die. In the case in FIG. 6C (radius r=r₂), more holes are born, and only one cluster is persistent. In the case of FIG. 6D (radius r=r₃), the number of clusters remains one, and one hole dies.

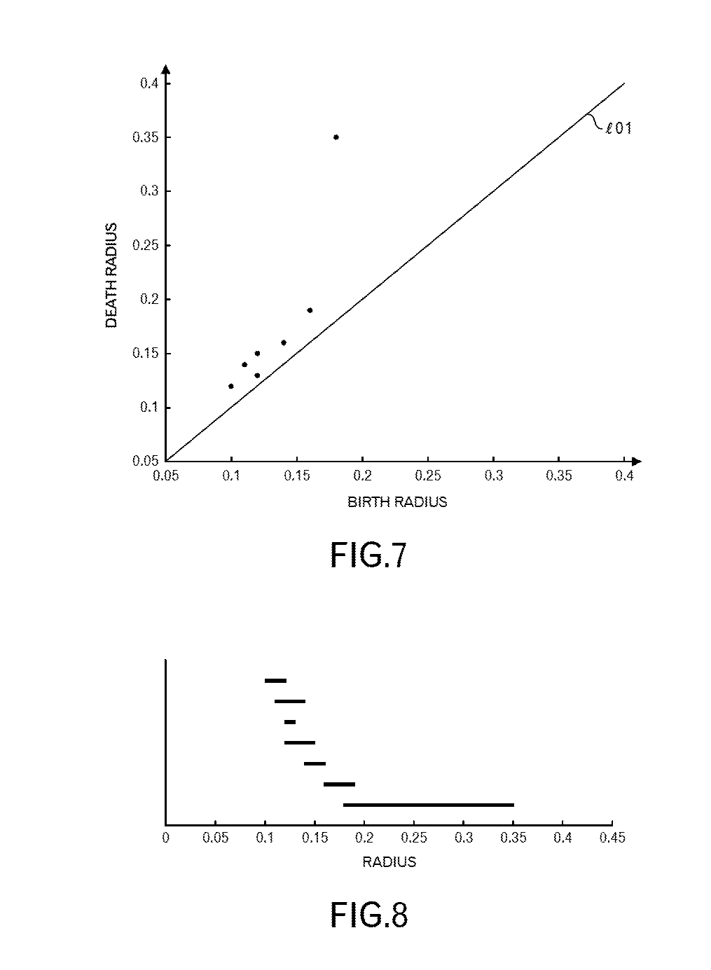

In the calculation processing of persistent homology, a birth radius and a death radius of elements (or in other words, holes) of a homology group are calculated. FIG. 7 is a diagram depicting an example of a persistence diagram that is generated based on a birth radius and a death radius that are found by calculation of the persistent homology. In FIG. 7, the horizontal axis represents a birth radius and the vertical axis represents a death radius. A birth radius and a death radius are equal on the straight line 101. Because a death radius is longer than a birth radius at each point, each point exists above the straight line 101, as illustrated in FIG. 7. When a perpendicular line from a point is drawn downward with respect to the horizontal axis, a distance between that point and a point of intersection between the perpendicular line and the straight line 101 represents a time length that a hole corresponding to that point is persistent in the object.

Moreover, by using a birth radius and a death radius of holes, it is possible to generate a barcode diagram such as illustrated in FIG. 8. In FIG. 8, the horizontal axis represents a radius, and each line segment corresponds to one hole. A radius that corresponds to the left end of the line segment is a birth radius of a hole, and a radius that corresponds to a right end of the line segment is a death radius of the hole. The line segment is called a persistent interval. From this kind of barcode diagram, it is seen that when a radius is 0.18, for example, there are two holes.

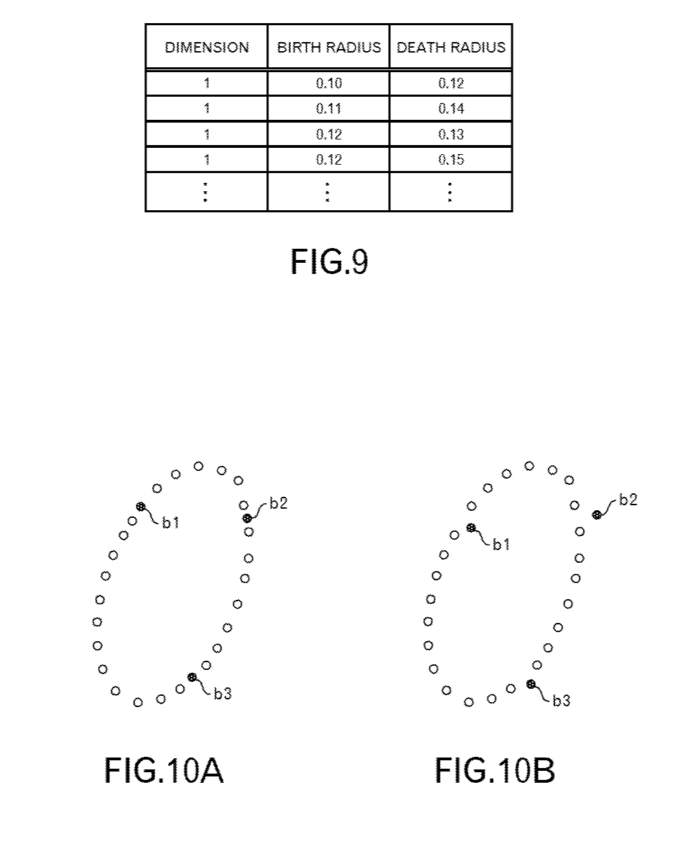

FIG. 9 is a diagram depicting an example of data (hereinafter, referred to as barcode data) for generating a persistence diagram and barcode diagram. A value that represents a hole dimension, a birth radius of a hole and a death radius of the hole are included in the example in FIG. 9. In step S3, barcode data is generated for each hole dimension.

By executing processing such as described above, a similarity relationship between barcode data that is generated by a certain pseudo attractor and barcode data that is generated from another pseudo attractor is equivalent to similarity relationship between pseudo attractors. Therefore, a relationship between a pseudo attractor and barcode data is a one-to-one relationship.

In other word, when pseudo attractors are the same, generated barcode data are the same. That is, when rules of change in series data are the same, generated barcode data are the same. On the other hand, when barcode data are the same, pseudo attractors are also the same. Moreover, when pseudo attracters are similar, barcode data are also similar, and thus conditions necessary for machine learning are satisfied. When pseudo attractors are different, barcode data are also different.

For details about persistent homology, refer to “Yasuaki Hiraoka, ‘Protein Structure and Topology: Introduction to Persistent Homology’, Kyoritsu Shuppan”, for example.

Returning to the explanation of FIG. 3, the removal unit 119 deletes data of persistent intervals whose lengths are less than a predetermined length, from the barcode data storage unit 109 (step S5). A length of a persistent interval is calculated by subtracting a birth radius from a death radius. The predetermined length is, for example, a length of an amount of time that corresponds to one portion of K equal portions (hereinafter, referred to as blocks) obtained by dividing a time from when a 0-dimensional hole is born until it dies. However, the predetermined length is not limited to a length of one block, and may also be a length of plural blocks.

Elements whose time from birth to death is short mostly occur due to noise that is added to a time series. By deleting data of persistent intervals whose lengths are less than the predetermined length, it is possible to lessen an effect of noise, and thus it becomes possible to improve classification performance. However, a target of deletion is taken to be data of persistent intervals whose dimension is 1 or more.

The effect of noise will be explained using FIGS. 10A to 14B. Values included in series data that corresponds to the pseudo attractor illustrated in FIG. 10A are shifted by noise that occurs at a certain time. As a result, the pseudo attractor illustrated in FIG. 10B is obtained. In FIG. 10B, point b1, point b2 and point b3 are shifted from the original positions.

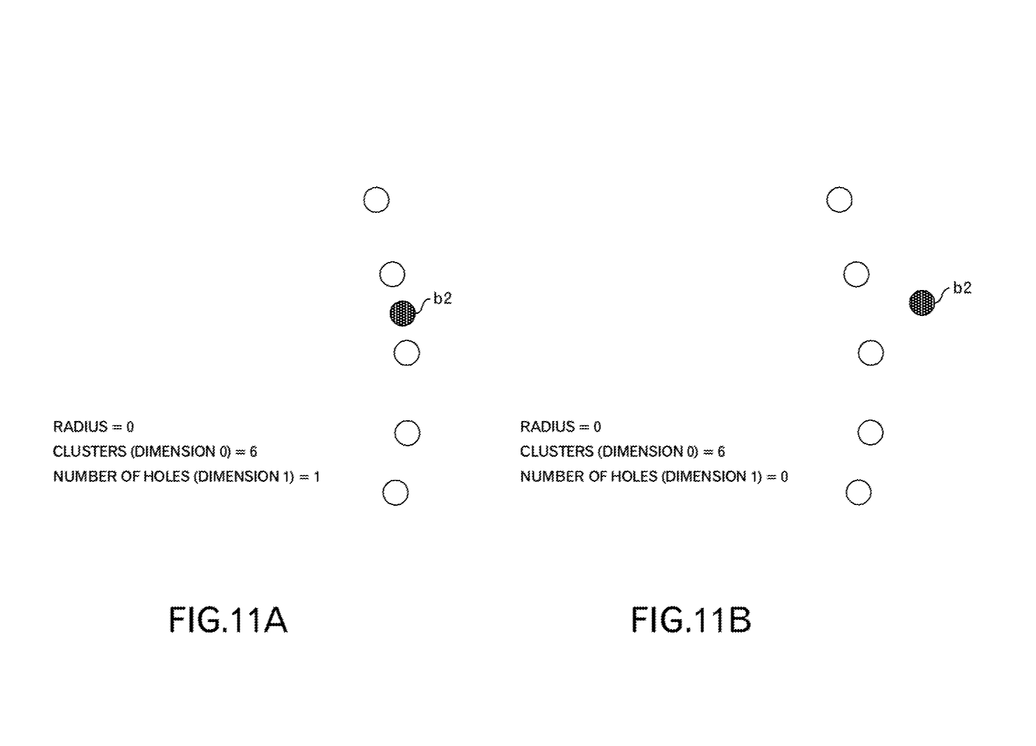

Here, attention will be paid to an effect due to shifting of point b2. As illustrated in FIGS. 11A and 11B, at the instant that the radius of spheres is 0, the number of clusters when there is no noise and when there is noise is 6, and the number of holes is 0.

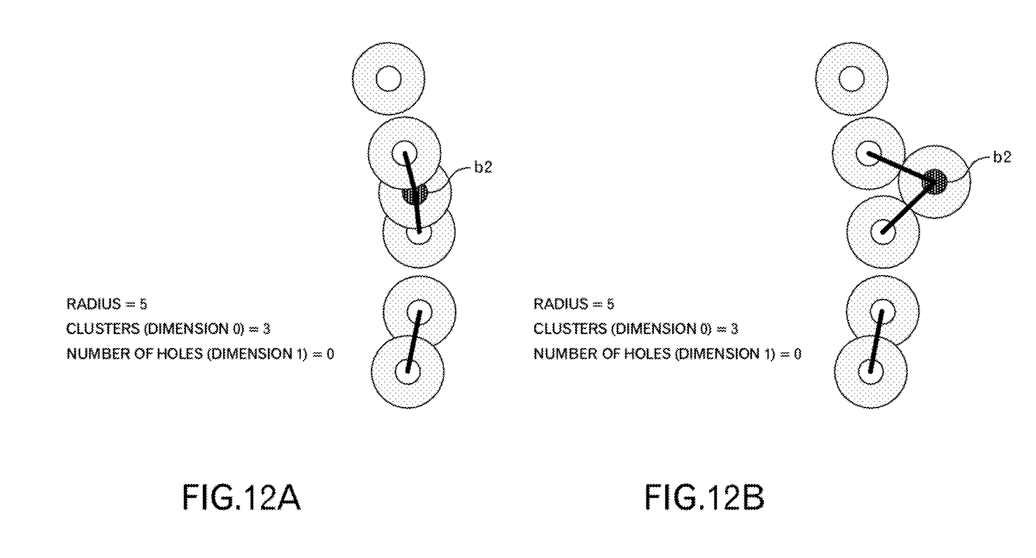

As illustrated in FIGS. 12A and 12B, at the instant when the radius is 5, the number of clusters when there is no noise and when there is noise is 3 and the number of holes is 0. However, the relationship between the sphere for point b2 and spheres around that sphere is different.

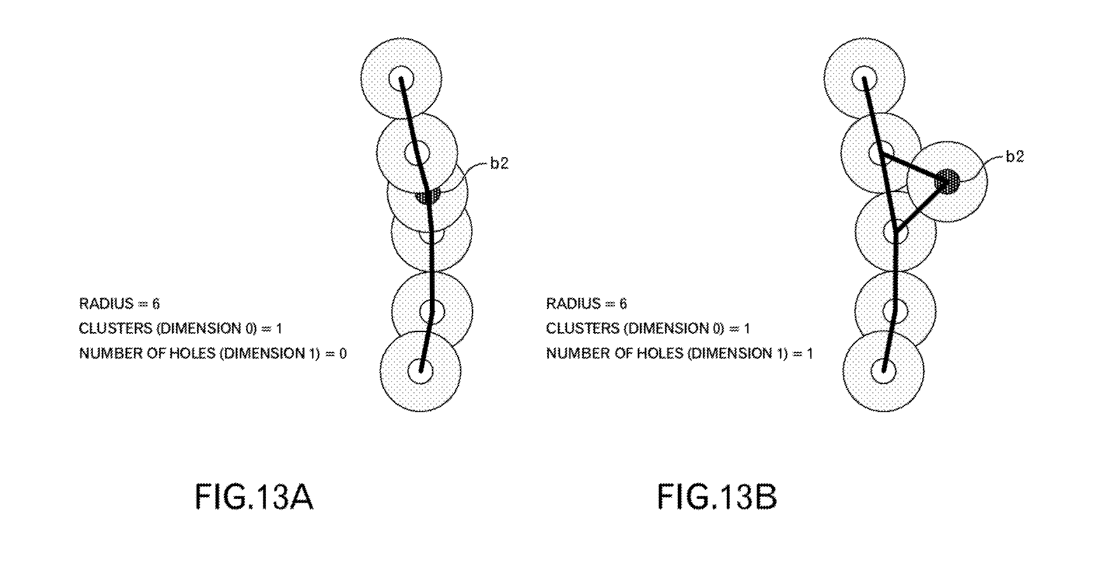

As illustrated in FIG. 13A, at the instant that the radius of spheres is 6, the number of clusters when there is no noise is 1 and the number of holes is 0. However, when there is noise, the number of clusters is 1 and the number of holes is 1 (FIG. 13B). In this way, when there is noise, a hole is born and the homology group is different.

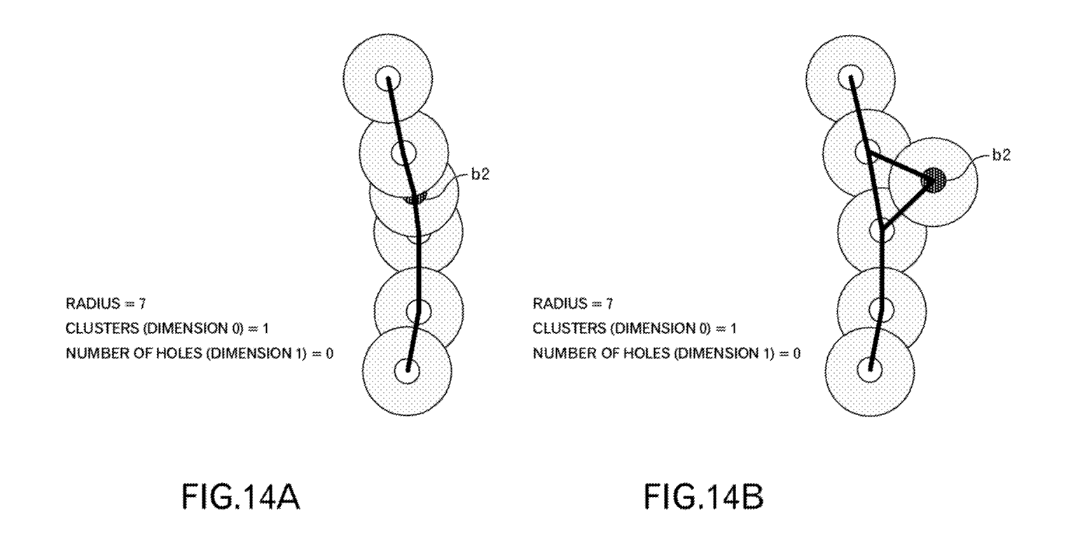

As illustrated in FIGS. 14A and 14B, at the instant when the radius of spheres is 7, the number of clusters when there is no noise and when there is noise is 1, and the number of holes is 0. Therefore, when there is noise, a hole is born in part of a time period from when the radius goes 6 to when the radius goes to 7.

As explained using FIGS. 10A to 14B, when noise occurred, there is a case where a one-dimensional or greater hole is born only for a short time. By executing the processing of step S5, data that is generated in both cases is nearly the same, and thus the effect of noise is able to be removed.

Data of persistent intervals having a length that is less than the predetermined length is deleted, and thus a similarity relationship among barcode data after data is deleted is not strictly equivalent to a similarity relationship among original barcode data. When data is not deleted, the similarity relationships are equivalent.

Returning to the explanation of FIG. 3, the third generator 111 reads out barcode data that is stored in the barcode data storage unit 109. Then, the third generator 111 integrates the read out barcode data and generates series data from the integrated barcode data (step S7). The third generator 111 stores the generated series data in the second series data storage unit 113.

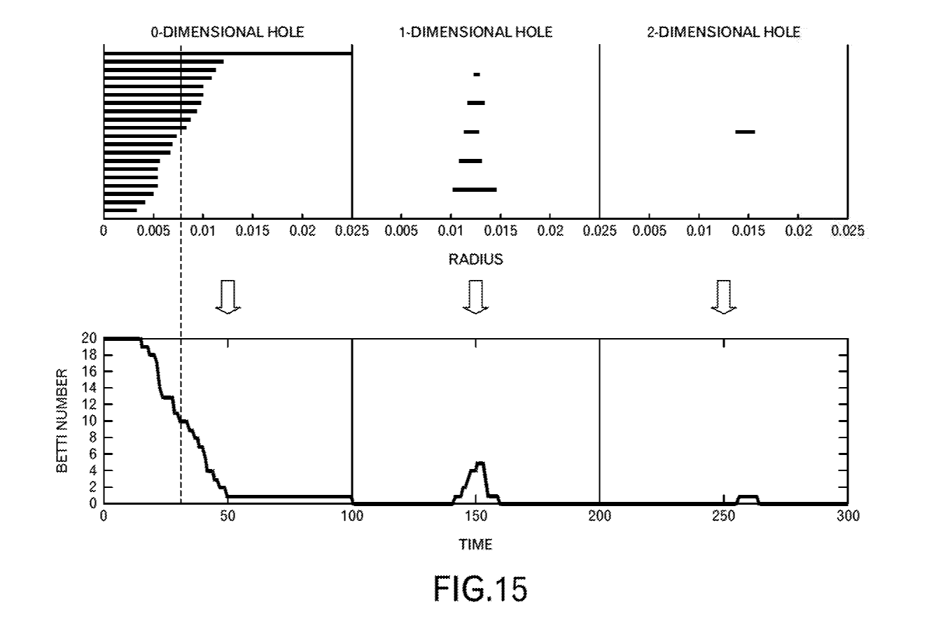

As described above, barcode data is generated for each hole dimension, and thus the third generator 111 generates one block of barcode data by combining barcode data of plural hole dimensions. Series data is data that represents a relationship between a radius (in other words, time) of spheres in persistent homology and a Betti number. A relationship between barcode data and generated series data will be explained using FIG. 15. The upper graph is a graph that is generated from barcode data, and the horizontal axis represents a radius. The lower graph is a graph that is generated from series data, and the vertical axis represents a Betti number and the horizontal axis represents time. As described above, the Betti number represents the number of holes; for example, in the upper graph, the number of holes that exist when the radius corresponds to the dashed line is 10, and thus in the lower graph, the Betti number that corresponds to the dashed line is also 10. The Betti number is calculated for each block. The lower graph is a graph of artificial time series data, and thus the values themselves along the horizontal axis do not have meaning.

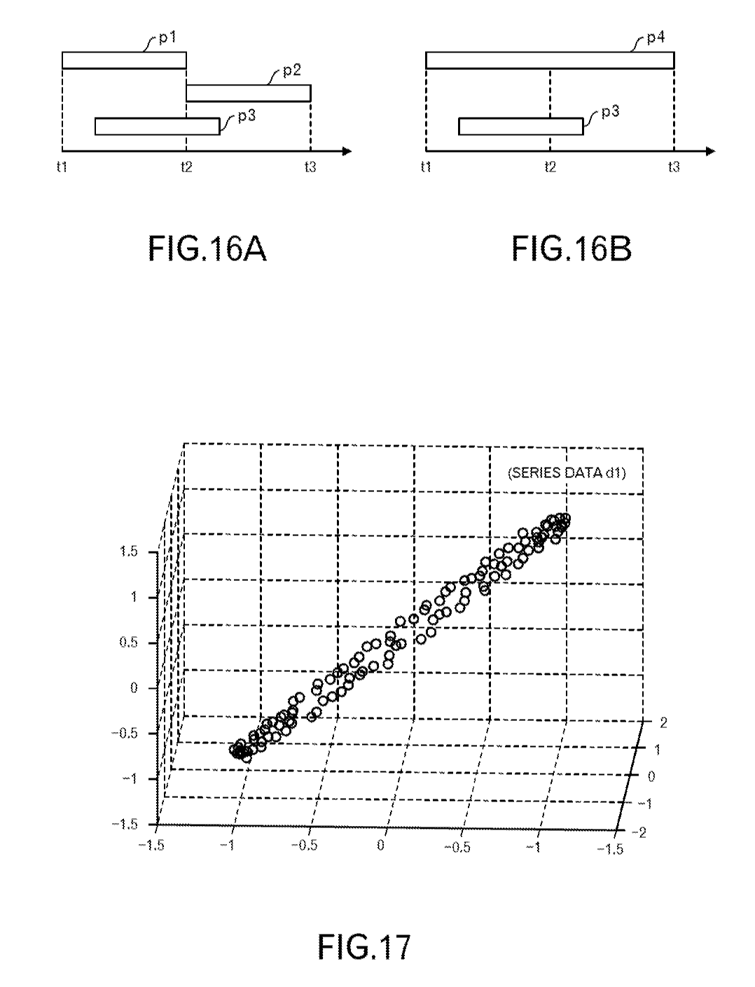

Basically, the same series data is obtained from the same barcode data. In other words, when original pseudo attractors are the same, the same series data are obtained. However, a case in which the same series data are obtained from different barcodes rarely occurs. For example, consider barcode data such as illustrated in FIGS. 16A and 16B. This barcode data is data related to holes of one or more dimension. In the case in FIG. 16A, persistent interval p1 starts at time t1 and ends at time t2, and persistent interval p2 starts at time t2 and ends at time t3. On the other hand, in the case in FIG. 16B, persistent interval p4 starts at time t1 and ends at time t3. In both cases, persistent interval p3 are the same.

In such a case, completely the same series data are obtained from the barcode data in both cases, and thus it is not possible to distinguish between both cases by the series data. However, a possibility that such a phenomenon will occur is extremely low. Moreover, the pseudo attractors in both cases are originally similar, and an effect on classification by machine learning is extremely small, and thus there is no problem even when a phenomenon such as described above occurs.

Therefore, a similarity relationship between series data that is generated from certain barcode data and series data that is generated from different barcode data is equivalent to a similarity relationship between barcode data as long as a rare case such as described above does not occur. From the above, even though the definition of distance between data changes, a similarity relationship between series data that is generated from barcode data is mostly equivalent to the similarity relationship between original series data.

An image of a point set that is represented by a pseudo attractor is sparse image data, and thus identification is difficult and classification using machine learning is difficult. Moreover, in barcode data such as described above, the number of barcodes is not fixed, and thus handling barcodes as input for machine learning is difficult. However, in the case of series data such as described above, oscillation is lessened when compared with original series data, and is suitable for input of machine learning.

Returning to the explanation of FIG. 3, the machine learning unit 115 executes machine learning in which series data that is stored in the second series data storage unit 113 is used as input (step S9). The machine learning unit 115 stores the machine learning result in the learning result storage unit 117. The machine learning result includes a classification result for series data (in other words, the machine learning output), and may also include parameters when calculating output from input. Moreover, as described above, the machine learning of this embodiment may be supervised learning or unsupervised learning.

The machine learning unit 115 determines whether there is unprocessed series data (step S11). When there is unprocessed series data (step S11: YES route), the processing returns to step S1. When there is no unprocessed series data (step S11: NO route), the processing ends.

As described above, by executing persistent homology calculation, it is possible to reflect rules of change in original series data on barcode data. As a result, it becomes possible to perform classification according to the rules of change of original series data by using machine learning.

Calculation for persistent homology is a topological method, and has been used for analysis of a structure of a static object (for example, a protein, a molecular crystal, a sensor network or the like) that is represented by a set of points. On the other hand, in this embodiment, a set of points (or in other words, a pseudo attractor), which expresses a rule of change of data that continuously change as time passes, is a target of calculation. In this embodiment, analyzing structure of a set of points itself is not a purpose of the calculation, and thus the target and purpose are completely different from those of typical calculation of persistent homology.

Moreover, the number of barcodes in the barcode data that is generated by calculation for persistent homology is not fixed, and thus it is difficult to use the barcode data itself as input for machine learning. Therefore, in this embodiment, by converting barcode data that is derived from series data again to series data, it is possible to use that barcode data as input for machine learning, which lessens oscillation and improves accuracy of classification.

Furthermore, as described above, by applying this embodiment, it is possible to remove an effect of noise that is included in series data. This will be explained by concrete examples in FIGS. 17 to 24D.

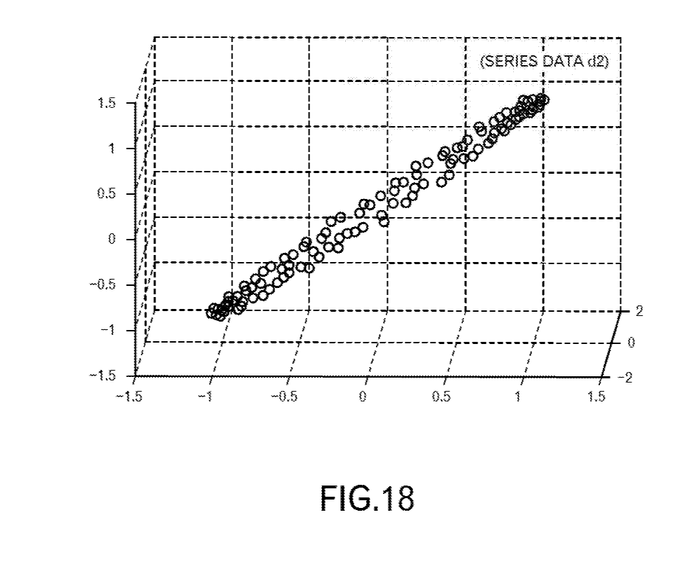

Examples of pseudo attractors are illustrated in FIG. 17 and FIG. 18. FIG. 17 is a diagram depicting a pseudo attractor for series data d1 which is time series data, and FIG. 18 is a diagram depicting a pseudo attractor for series data d2 which is time series data. Rules of change of both series data are the same, however, states of shifts due to noise are different.

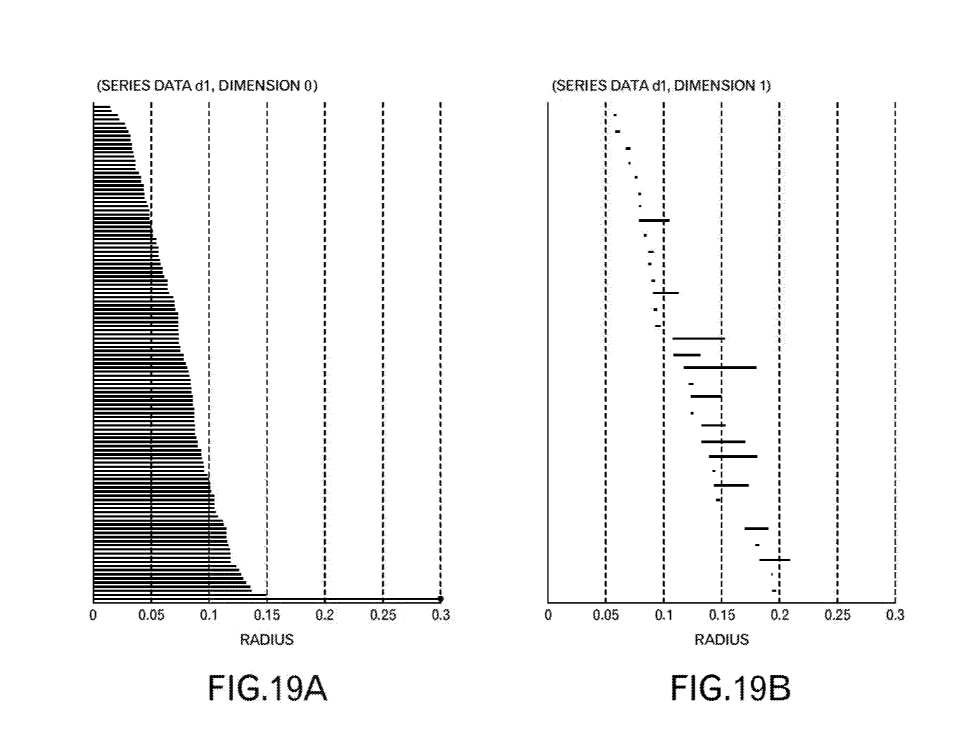

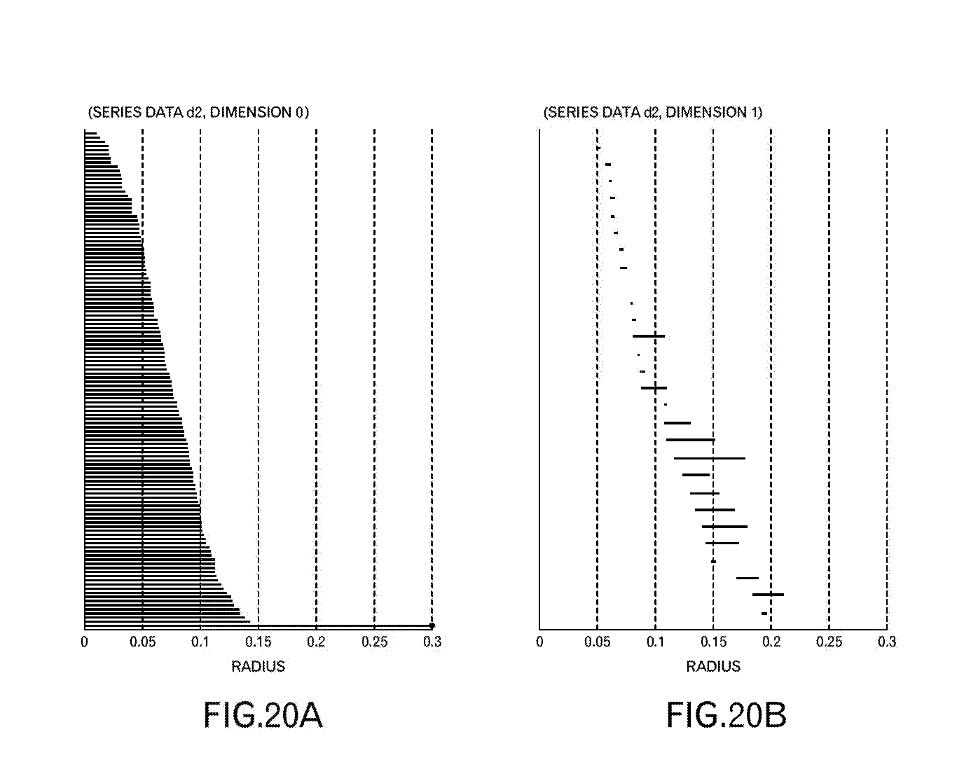

FIGS. 19A to 20B are diagrams depicting examples of barcode data that are generated from pseudo attractors. FIG. 19A is a diagram for barcode data of a 0-dimensional hole that is generated from the pseudo attractor depicted in FIG. 17, and FIG. 19B is a diagram for barcode data for a 1-dimensional hole that was generated from the pseudo attractor depicted in FIG. 17. FIG. 20A is a diagram for barcode data of a 0-dimensional hole that is generated from the pseudo attractor depicted in FIG. 18, and FIG. 20B is barcode data for a 1-dimensional hole that was generated from the pseudo attractor depicted in FIG. 18.

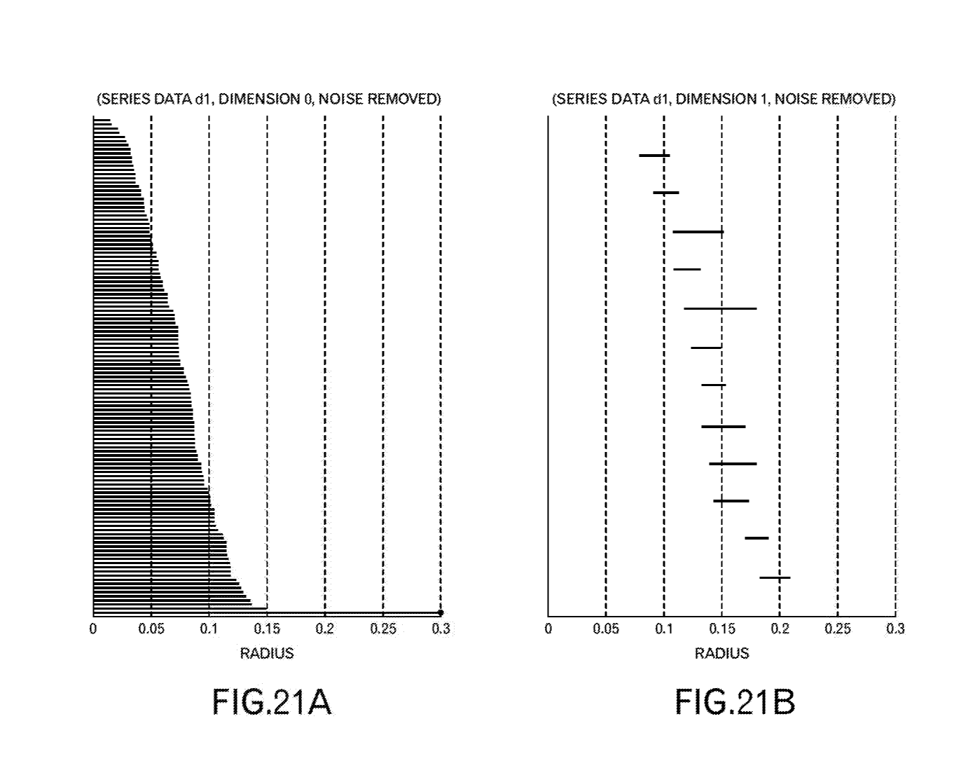

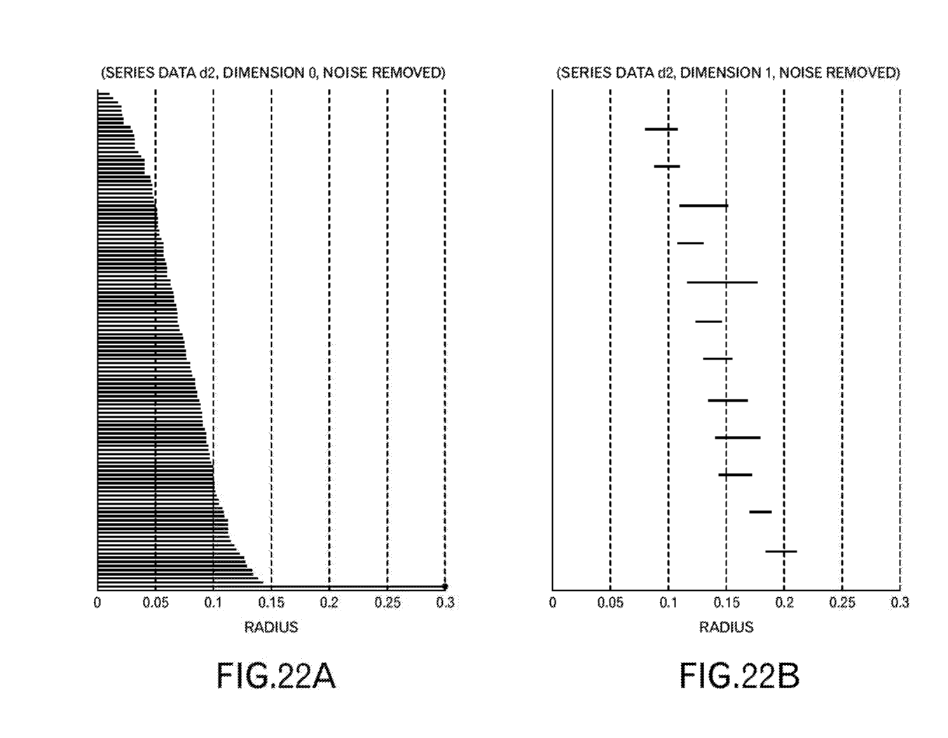

FIGS. 21A to 22B are diagrams depicting examples of barcode data from which noise was removed. Barcode data in FIG. 21A is the same as the barcode data depicted in FIG. 19A, and barcode data in FIG. 21B is barcode data for which processing to remove noise was performed on the barcode data depicted in FIG. 19B. Barcode data in FIG. 22A is the same as the barcode data depicted in FIG. 20A, and barcode data in FIG. 22B is barcode data for which processing to remove noise was performed on the barcode data depicted in FIG. 20B.

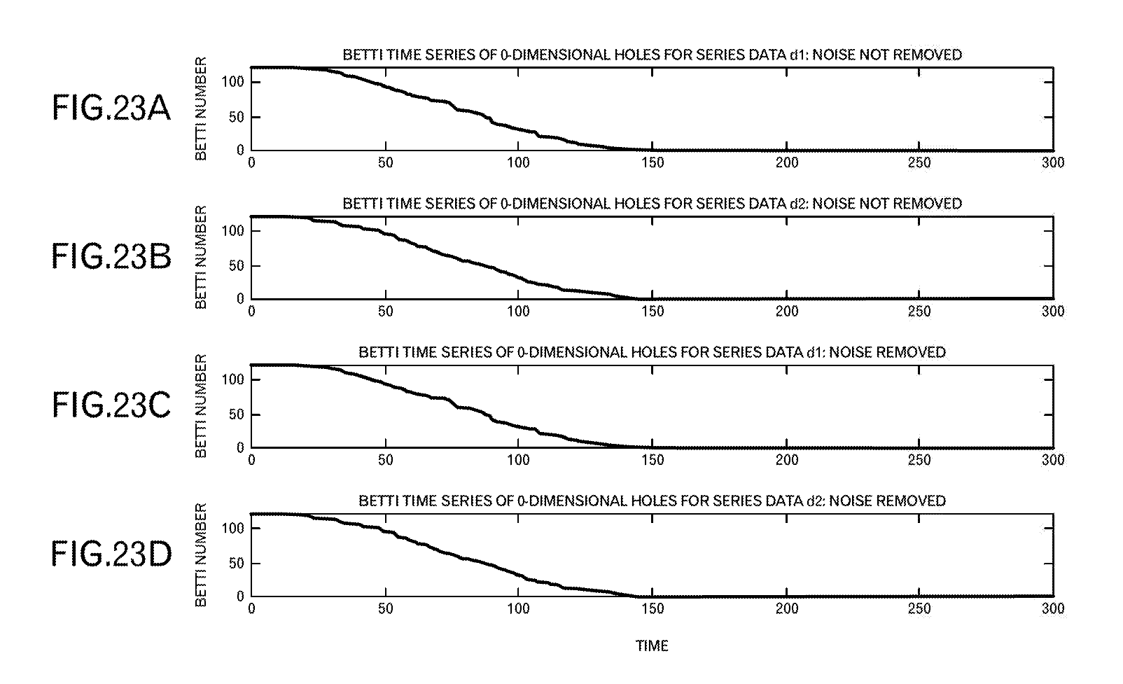

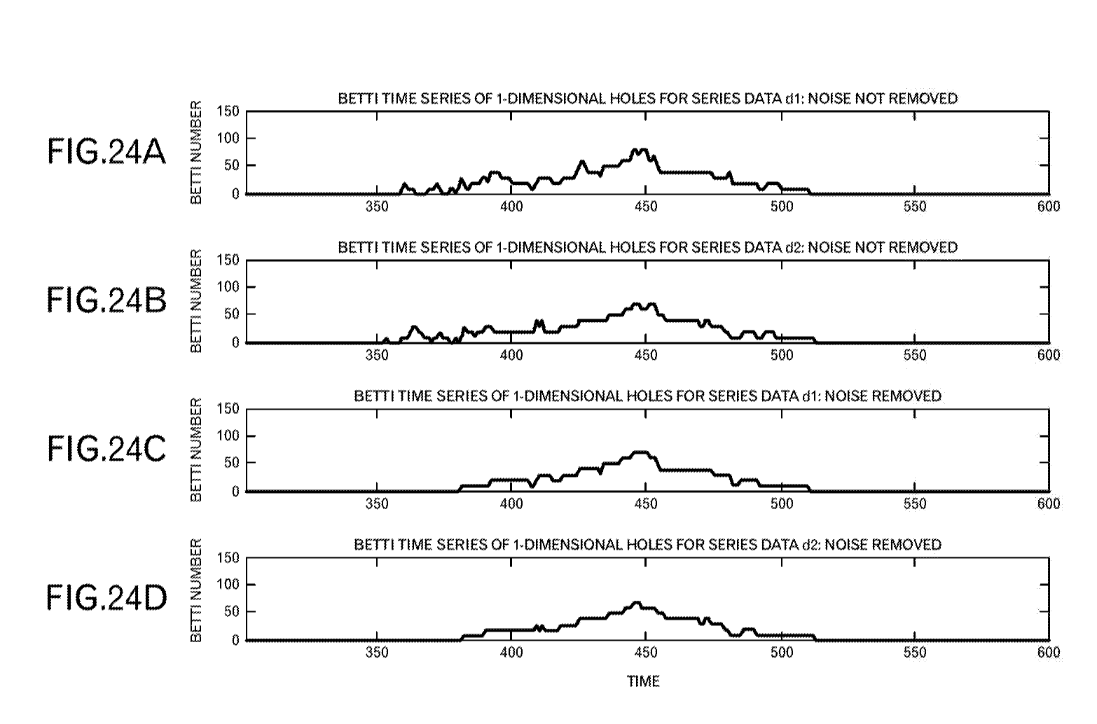

FIGS. 23A to 23D are diagrams depicting series data for 0-dimensional holes, which was generated from barcode data (here, this is called a Betti time series). In this embodiment, noise is not removed for 0-dimensional holes. However, in order to be able to compare with FIGS. 24A to 24D which are diagrams for 1-dimensional holes, FIGS. 23A to 23D have the same structure as FIGS. 24A to 24D. FIG. 23A is a diagram for a Betti time series for series data d1 in which noise is not removed, FIG. 23B is a diagram for a Betti time series for series data d2 in which noise is not removed, FIG. 23C is a diagram for a Betti time series for series data d1 in which noise is removed, and FIG. 23D is a diagram for a Betti time series for series data d2 in which noise is removed.

FIGS. 24A to 24D are diagrams for series data for 1-dimensional holes which has been generated from barcode data (here, this is called a Betti time series). FIG. 24A is a diagram for a Betti time series for series data d1 in which noise is not removed, FIG. 24B is a diagram for a Betti time series for series data d2 in which noise is not removed, FIG. 24C is a diagram for a Betti time series for series data d1 in which noise is removed, and FIG. 24D is a diagram for a Betti time series for series data d2 in which noise is removed. As illustrated in FIGS. 24A to 24D, when noise is not removed, shapes of graphs are different particularly in an area where a radius is 350 to 400 in FIG. 24A and FIG. 24B, and there is much up-down oscillation. When executing machine learning for this kind of series data, accuracy of classification becomes worse (for example, both are classified indifferent groups). On the other hand, when noise is removed, shapes of graphs are similar in an area where a radius is 350 to 400 in FIG. 24C and FIG. 24D. Therefore, a possibility of wrong classification becomes low.

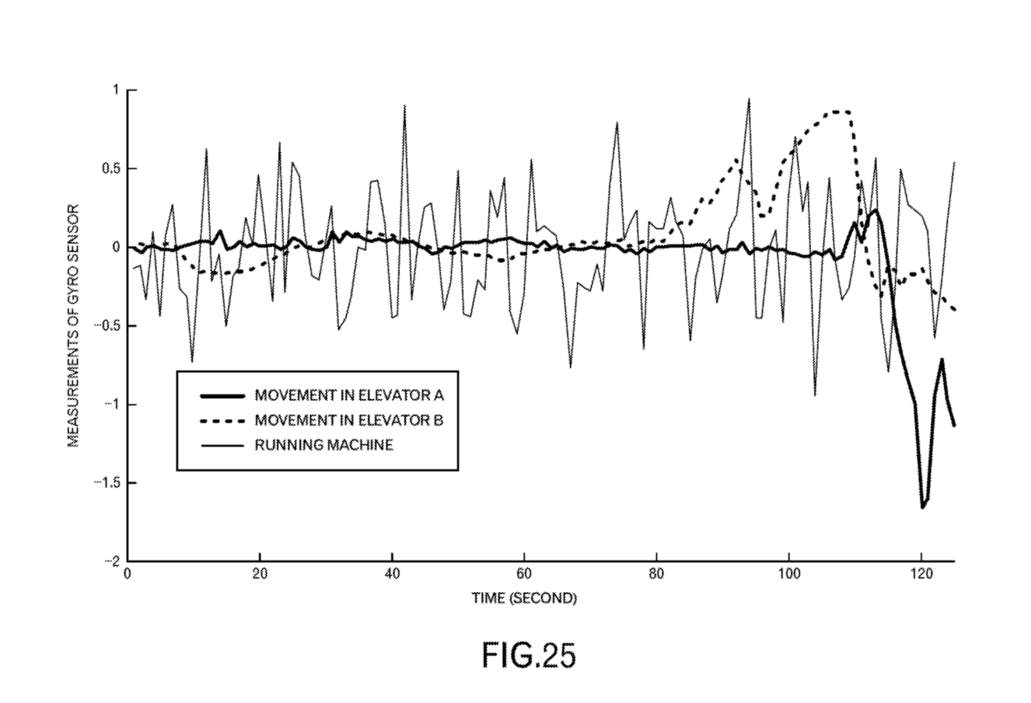

Data conversion until a time when the final series data is generated from the original series data will be explained in more detail below using FIGS. 25 to 41.

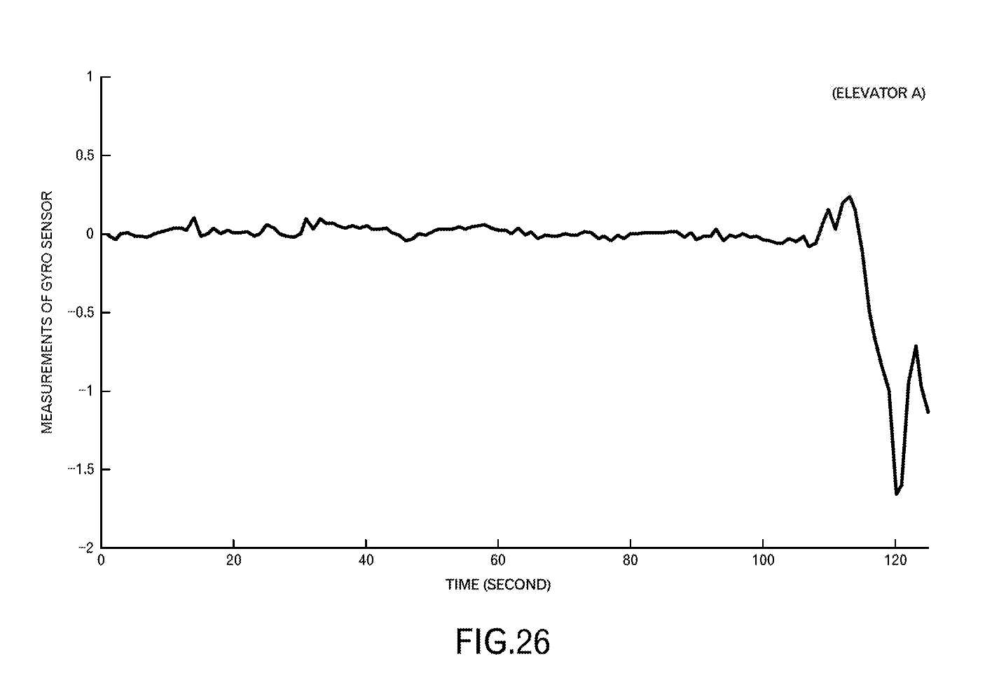

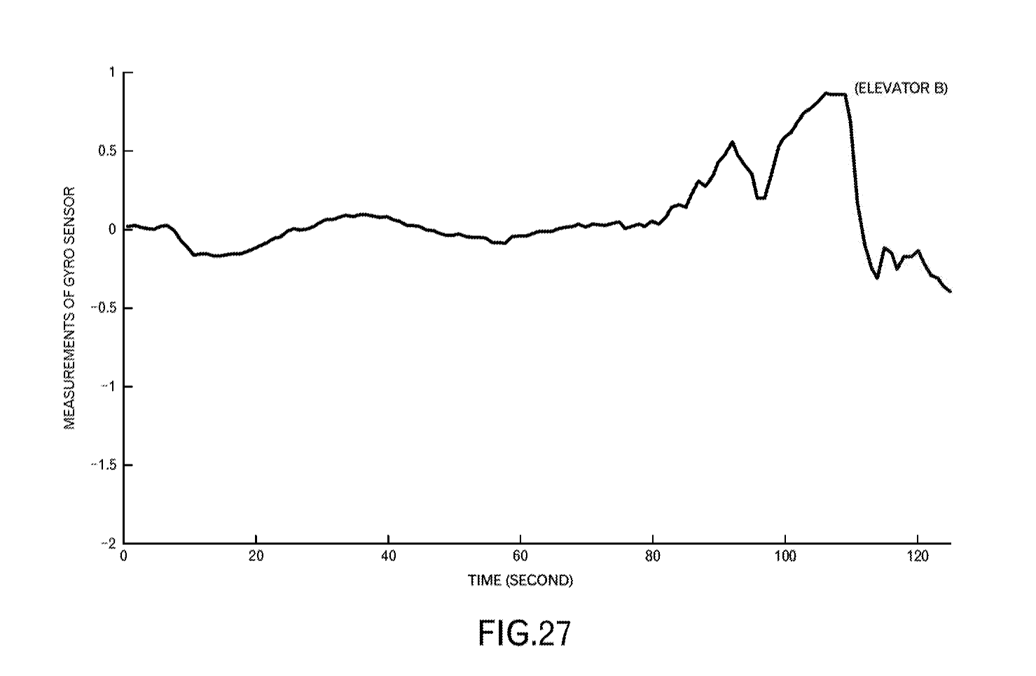

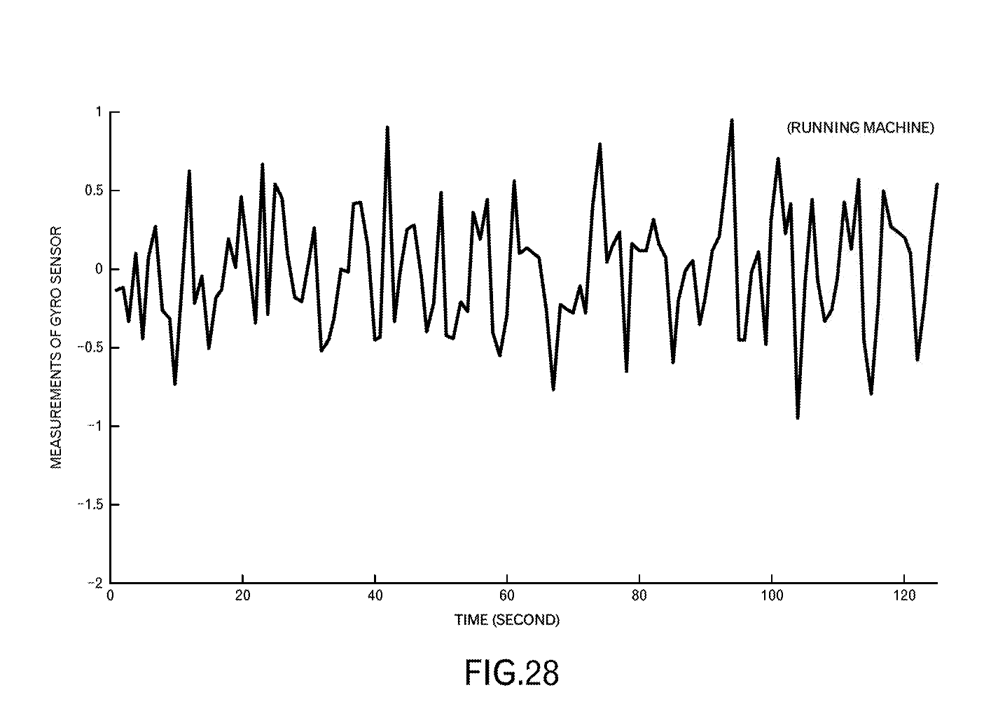

FIGS. 25 to 28 are diagrams for series data that will be used in the following explanation. FIG. 25 is a diagram in which three graphs of series data used in the following explanation is overlap. In FIG. 25, the vertical axis represents measurement values from a gyro sensor (hereinafter, referred to as sensor values), and the horizontal axis represents time. Thick solid line is a graph that represents sensor values that are obtained when moving inside an elevator A, the dashed line is a graph that represents sensor values that are obtained when moving inside an elevator B, and the solid line is a graph that represents sensor values that are obtained when exercising on a running machine. The gyro sensor is worn on a right arm of a person. FIG. 26 is a diagram depicting a graph only for elevator A, FIG. 27 is a diagram depicting a graph only for elevator B, and FIG. 28 is a diagram depicting a graph only for a running machine. As in FIG. 25, the vertical axis represents sensor values, and the horizontal axis represents time.

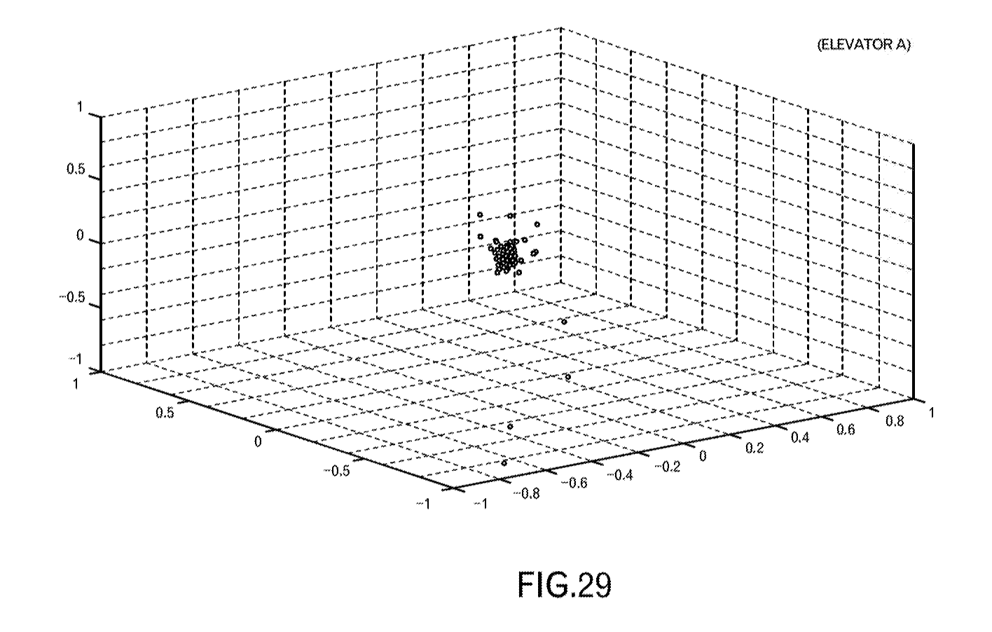

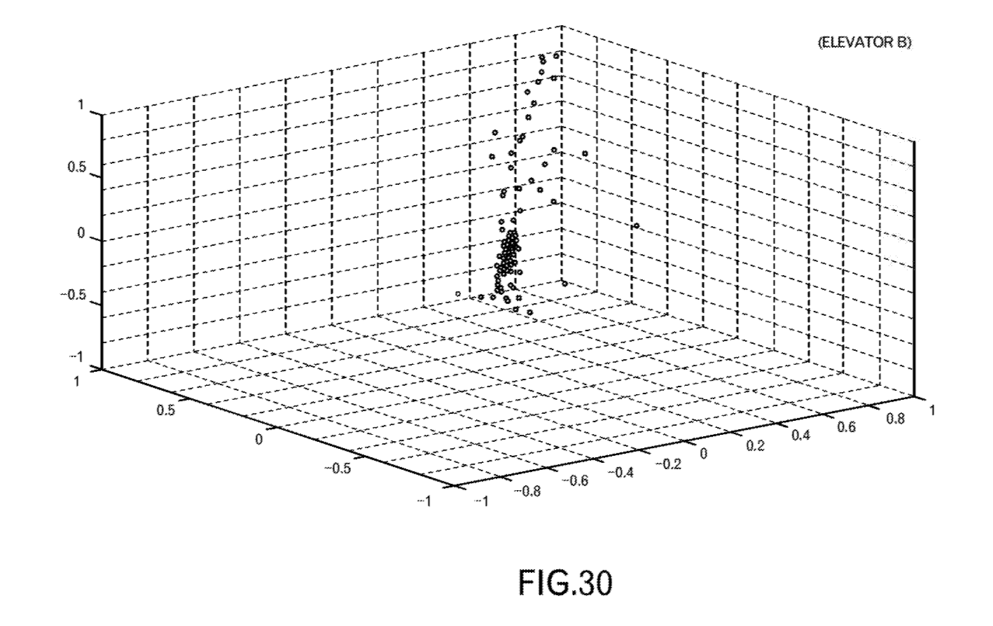

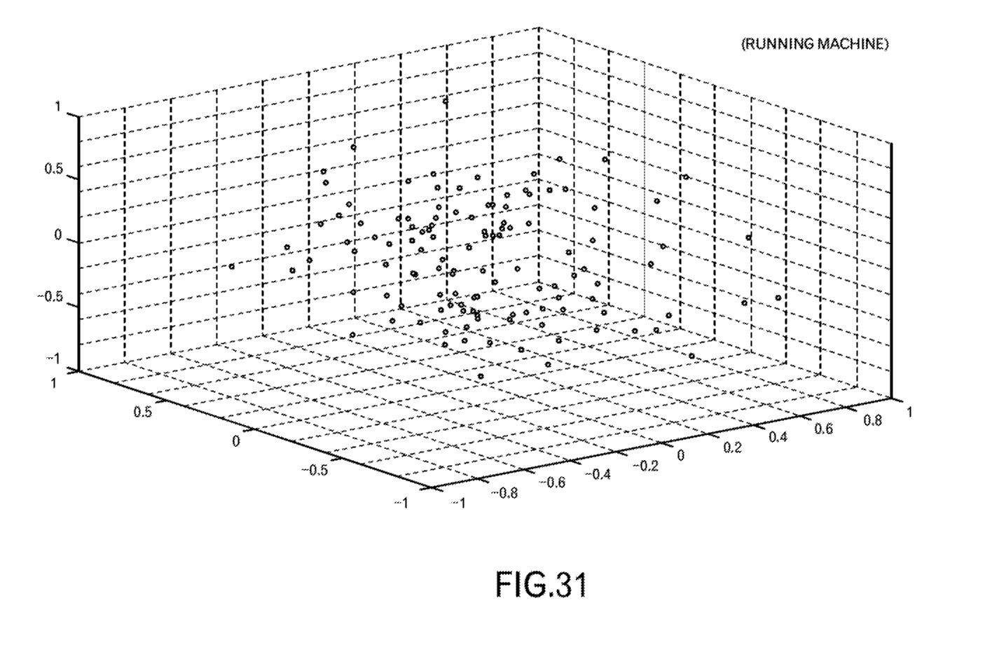

FIGS. 29 to 31 are diagrams depicting pseudo attractors. FIG. 29 is a diagram depicting a graph for a pseudo attractor for elevator A, FIG. 30 is a diagram depicting a graph for a pseudo attractor for elevator B, and FIG. 31 is a diagram depicting a graph for a pseudo attractor for the running machine. In FIGS. 29 to 31, the embedding dimension is 3. Coordinates of points themselves have no meaning.

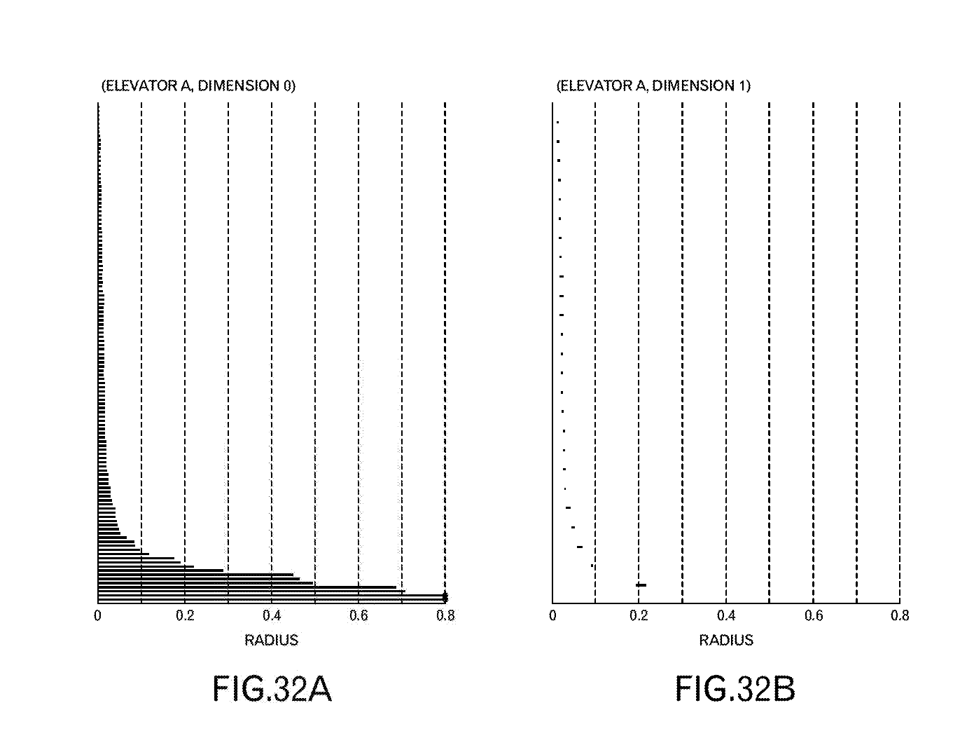

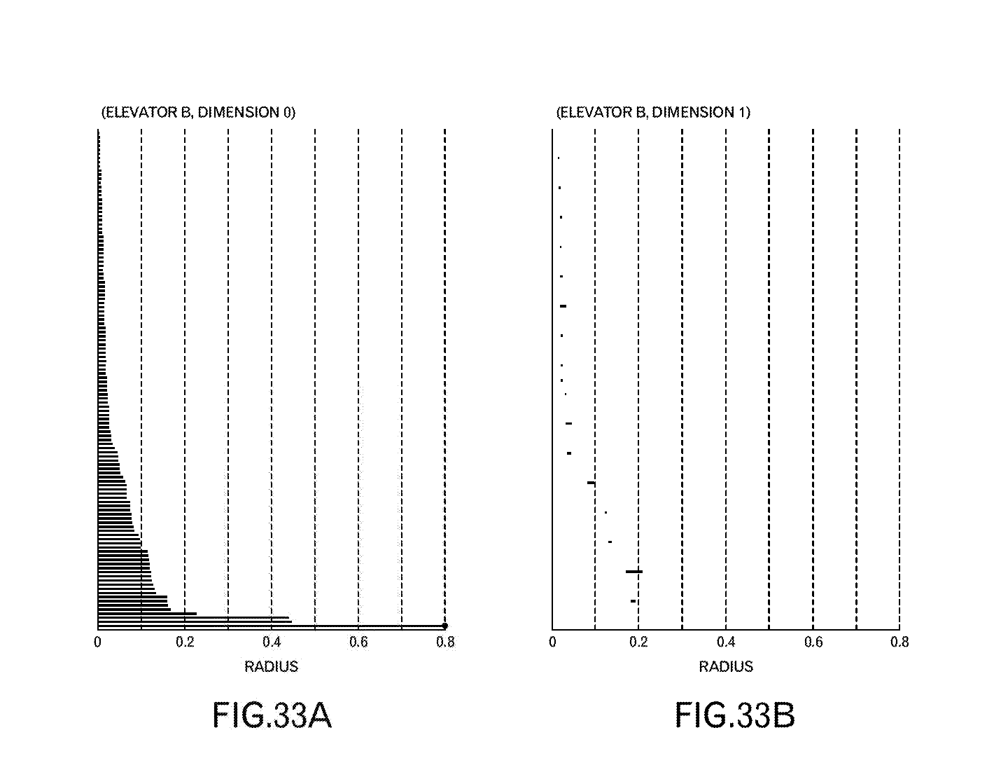

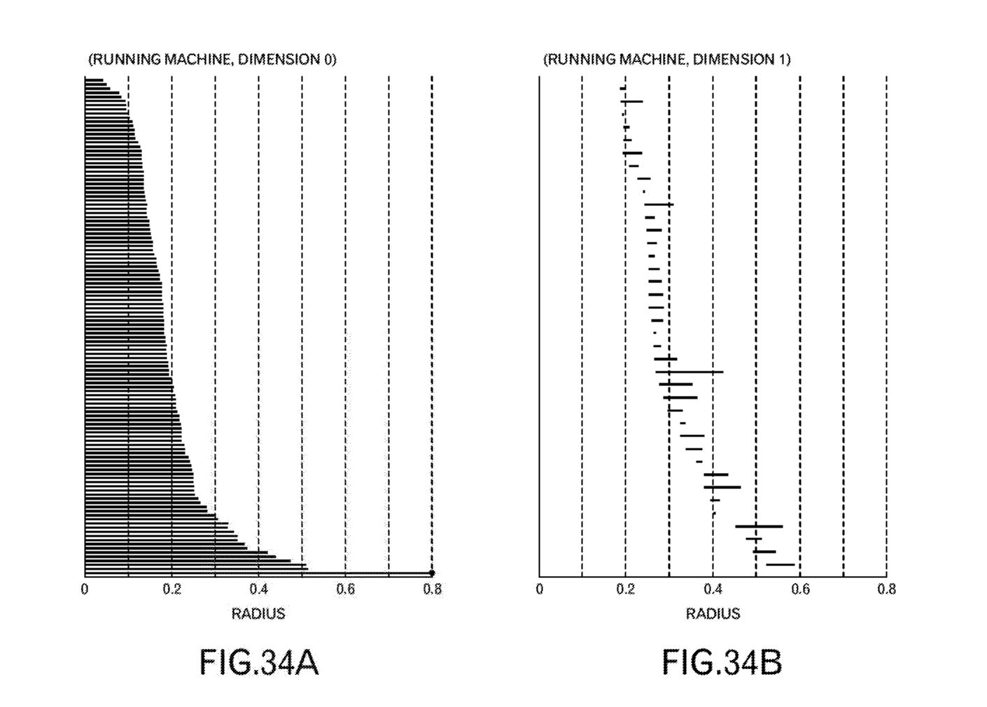

FIGS. 32A to 34B are diagrams for barcode data when noise is not removed. FIG. 32A is a diagram depicting a graph for barcode data of 0-dimensional holes for elevator A, and FIG. 32B is a diagram depicting a graph for barcode data of 1-dimensional holes for elevator A. FIG. 33A is a diagram depicting a graph of barcode data for 0-dimensional holes for elevator B, and FIG. 33B is a diagram depicting a graph of barcode data for 1-dimensional holes for elevator B. FIG. 34A is a diagram depicting a graph of barcode data for 0-dimensional holes for the running machine, and FIG. 34B is a diagram depicting a graph of barcode data for 1-dimensional holes for the running machine.

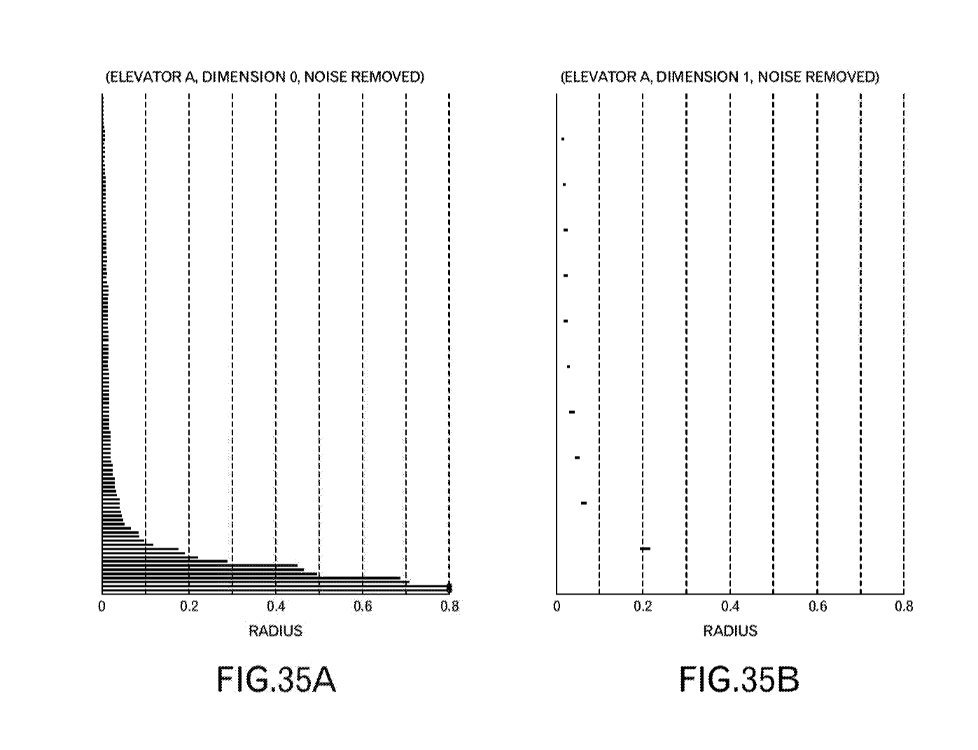

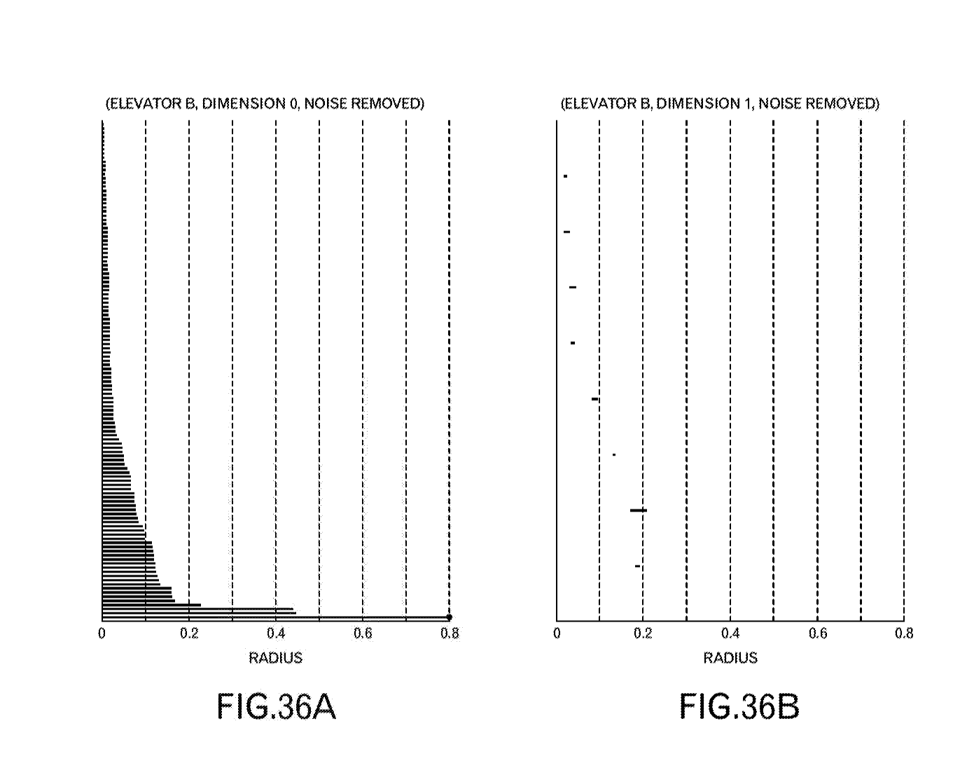

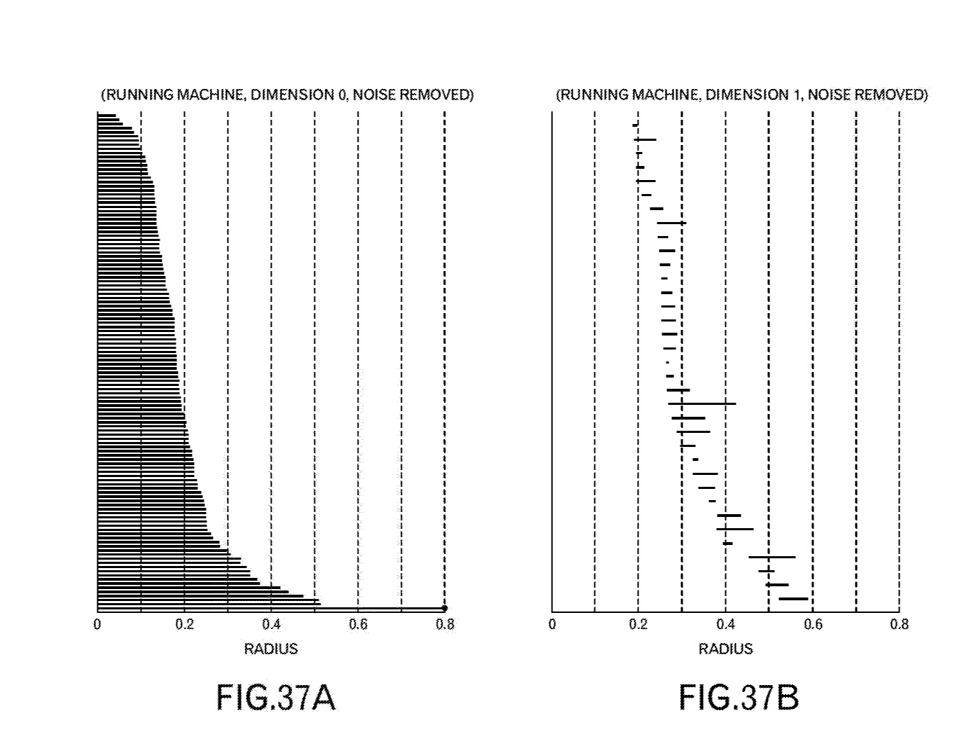

FIGS. 35A to 37B are diagrams for barcode data when noise is removed. FIG. 35A is a diagram depicting a graph for barcode data of 0-dimensional holes for elevator A, and FIG. 35B is a diagram depicting a graph for barcode data of 1-dimensional holes for elevator A. FIG. 36A is a diagram depicting a graph for barcode data of 0-dimensional holes for elevator B, and FIG. 36B is a diagram depicting a graph for barcode data of 1-dimensional holes for elevator B. FIG. 37A is a diagram depicting a graph for barcode data of 0-dimensional holes for the running machine, and FIG. 37B is a diagram depicting a graph for barcode data of 1-dimensional holes for the running machine.

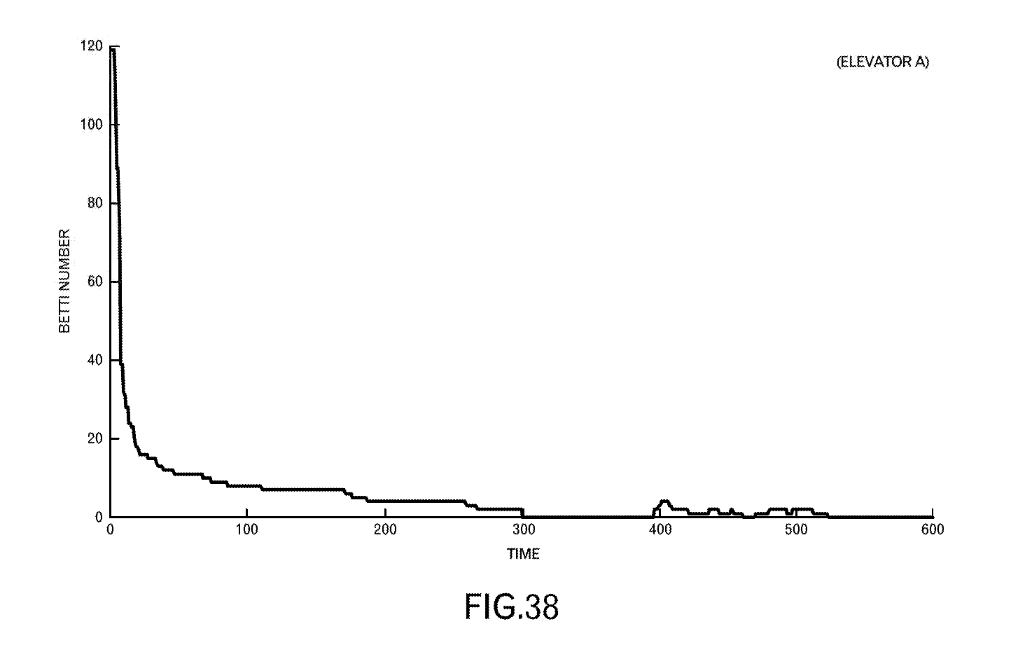

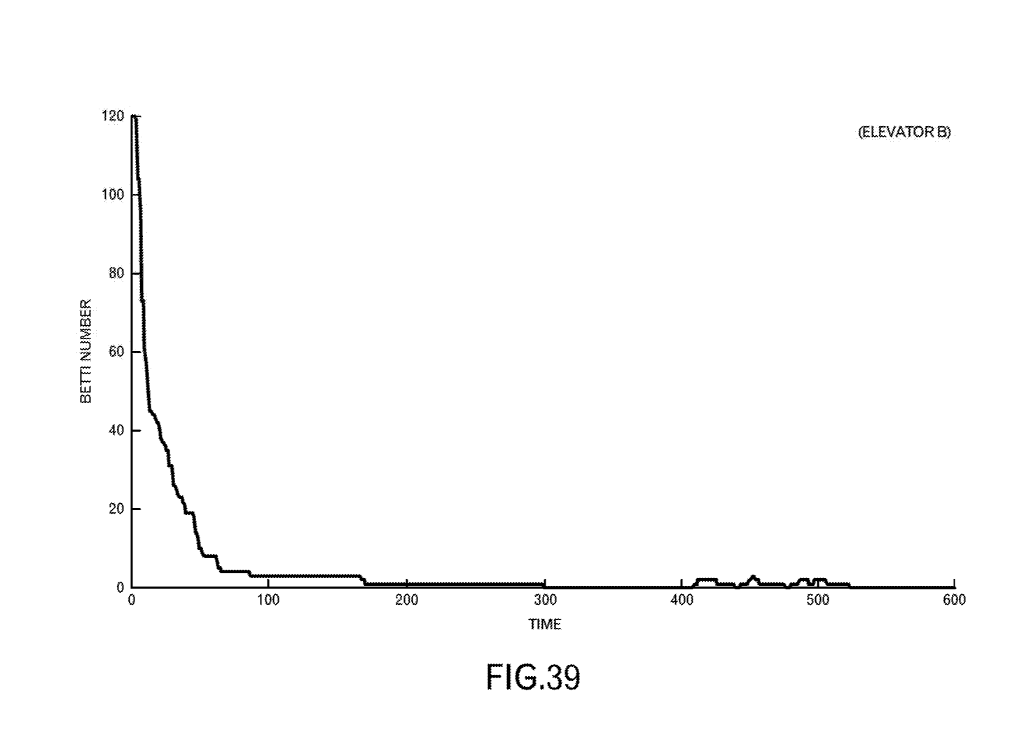

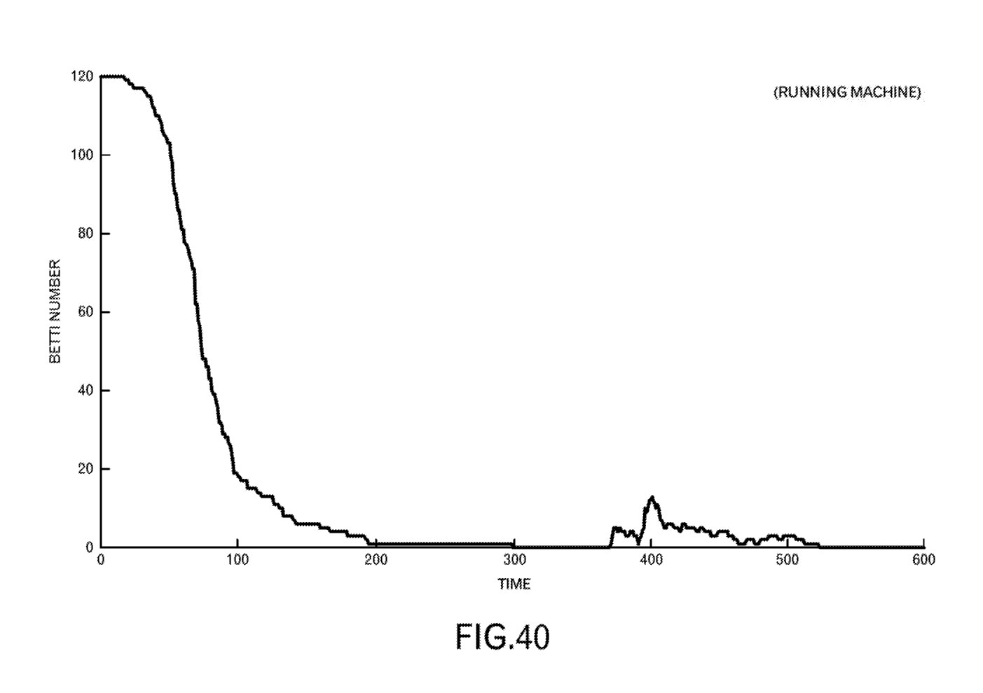

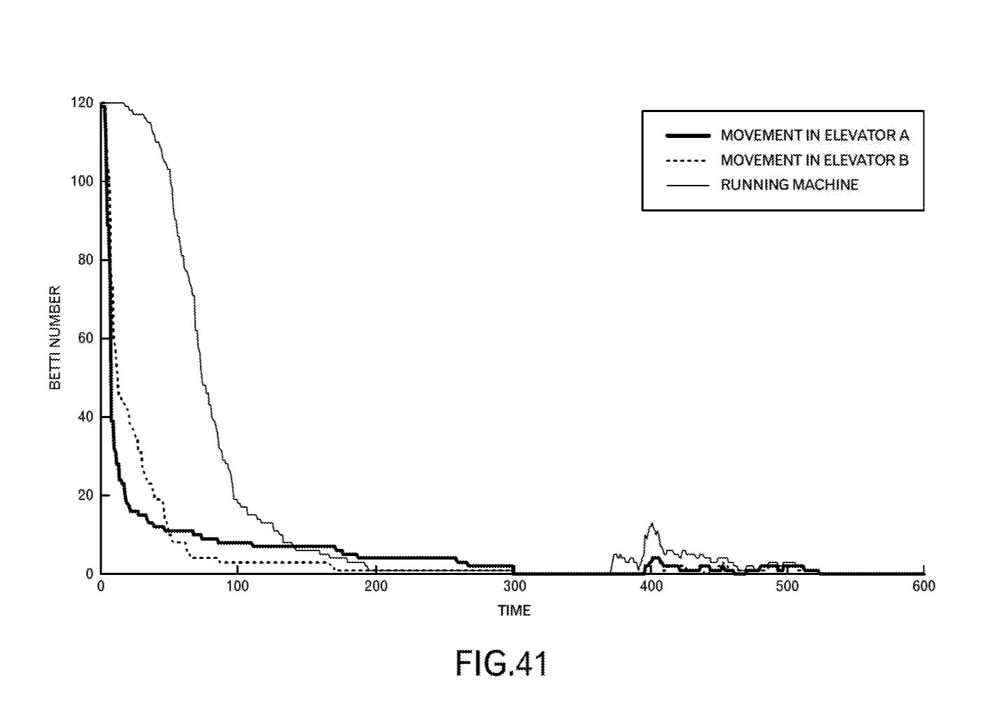

FIGS. 38 to 41 are diagrams depicting series data that is generated from barcode data (here, this is called a Betti time series). FIG. 38 is a diagram depicting a graph of a Betti time series for elevator A, FIG. 39 is a diagram depicting a graph of a Betti time series for elevator B, and FIG. 40 is a diagram depicting a graph of a Betti time series for the running machine. FIG. 41 is a diagram depicting a graph in which the three graphs illustrated in FIGS. 38 to 40 are overlapped. In FIGS. 38 to 41, the vertical axis represents a Betti number, and the horizontal axis represents time.

As illustrated in FIG. 41, for elevator A and elevator B, for which rules for controlling change in original series data are considered to be the same, the shapes of the Betti time series are similar. However, the shape of the Betti time series for the running machine, for which a rule for controlling change in original series data is considered not to be the same, differs from the shapes of the Betti time series for elevator A and the Betti time series for elevator B. Particularly, during the time from 0 to approximately 150, and during the time from approximately 380 to approximately 450, the shapes are remarkably different.

Therefore, by using the Betti time series of this embodiment, it becomes possible to properly classify original series data according to original rules of change, and thus to improve accuracy of classification.

### Embodiment 2

As was described in the explanation of the first embodiment, a similarity relationship among original series data is mostly equivalent (in other words, a 1-to-1 relationship) to a similarity relationship among series data that is generated from barcode data. However, when it is possible to translate certain series data (in other words, biasing) and superimpose that series data over other series data, a 1-to-1 relationship is not established.

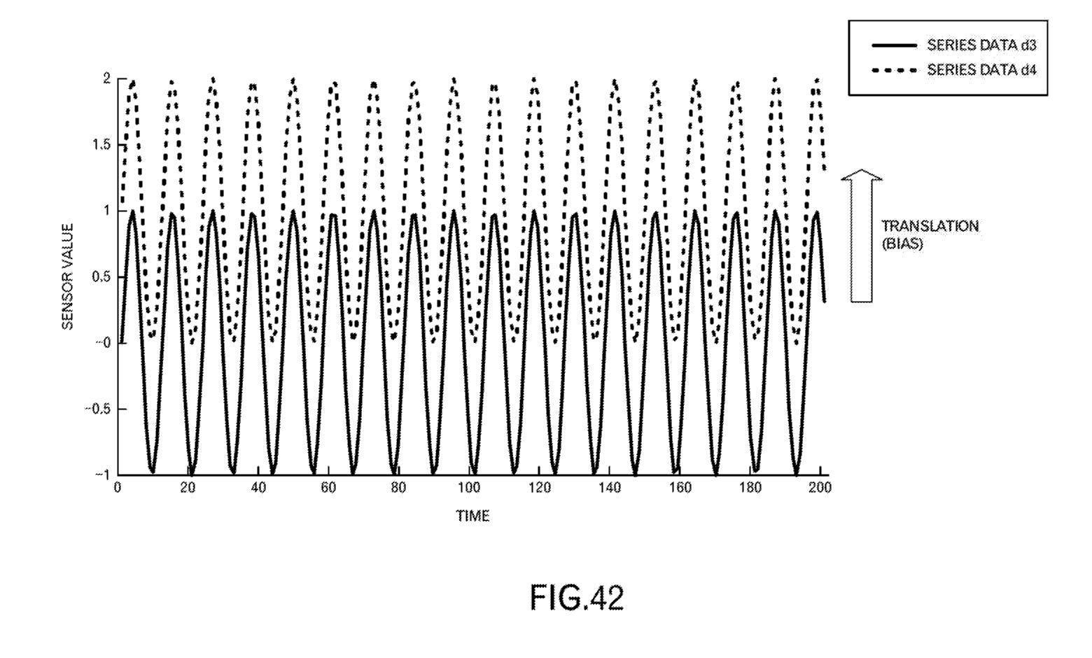

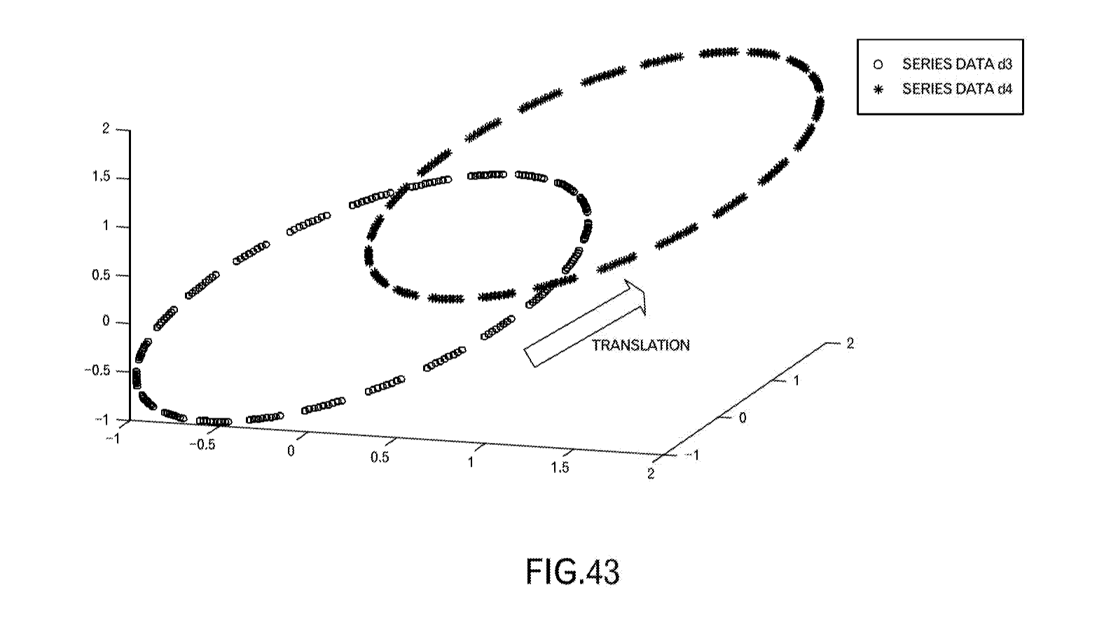

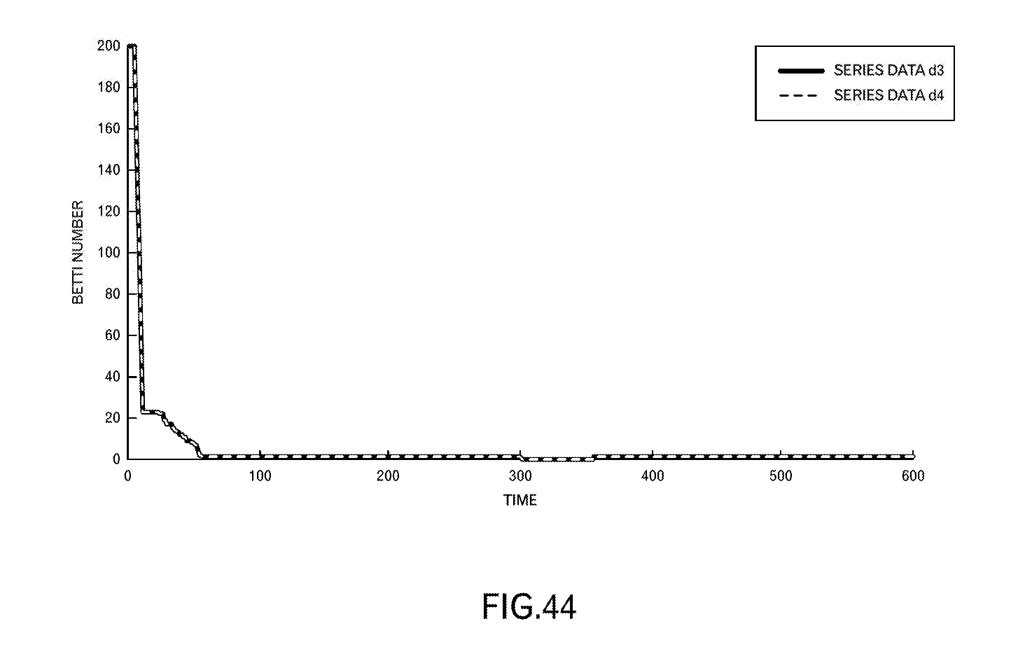

For example, as illustrated in FIG. 42, assume that there are series data d3 and series data d4 that is series data obtained by translating series data d3. In this case, as illustrated in FIG. 43, an arrangement of points inside the pseudo attractors is exactly the same, and is capable of being superimposed by translating both pseudo attractors. A result of calculation of persistent homology represents a state of an arrangement relationship of points, as illustrated in FIG. 44, the barcode data that are generated from both pseudo attractors match completely. Therefore, series data d3 and series data d4 correspond to the same barcode data.

In the following, a method for establishing a 1-to-1 relationship even when handling series data that are capable of being superimposed by translation will be explained.

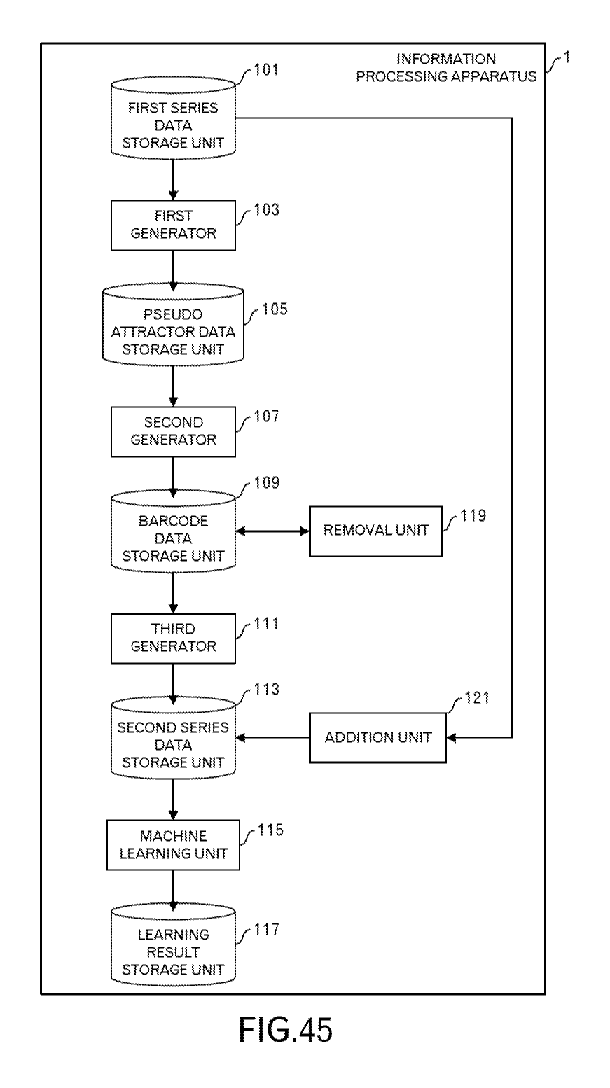

FIG. 45 is a functional block diagram of an information processing apparatus 1 in this second embodiment. The information processing apparatus 1 has a first series data storage unit 101, a first generator 103, a pseudo attractor data storage unit 105, a second generator 107, a barcode data storage unit 109, a third generator 111, a second series data storage unit 113, a machine learning unit 115, a learning result storage unit 117, a removal unit 119 and an addition unit 121.

The first generator 103 generates pseudo attractors from series data that is stored in the first series data storage unit 101, and stores the generated pseudo attractors in the pseudo attractor data storage unit 105. The second generator 107 generates barcode data from the pseudo attractors that are stored in the pseudo attractor data storage unit 105 for each dimension of element (in other words, hole) of persistent homology group, and stores the generated barcode data in the barcode data storage unit 109. The removal unit 119 deletes data related to noise of the data stored in the barcode data storage unit 109. The third generator 111 generates series data from the barcode data that is stored in the barcode data storage unit 109, and stores the generated series data in the second series data storage unit 113. The machine learning unit 115 executes machine learning using the series data that is stored in the second series data storage unit 113 as input, and stores the machine learning result (for example, classification result) in the learning result storage unit 117. The addition unit 121 generates additional data based on the data that is stored in the first series data storage unit 101, and adds that data to the series data that is stored in the second series data storage unit 113.

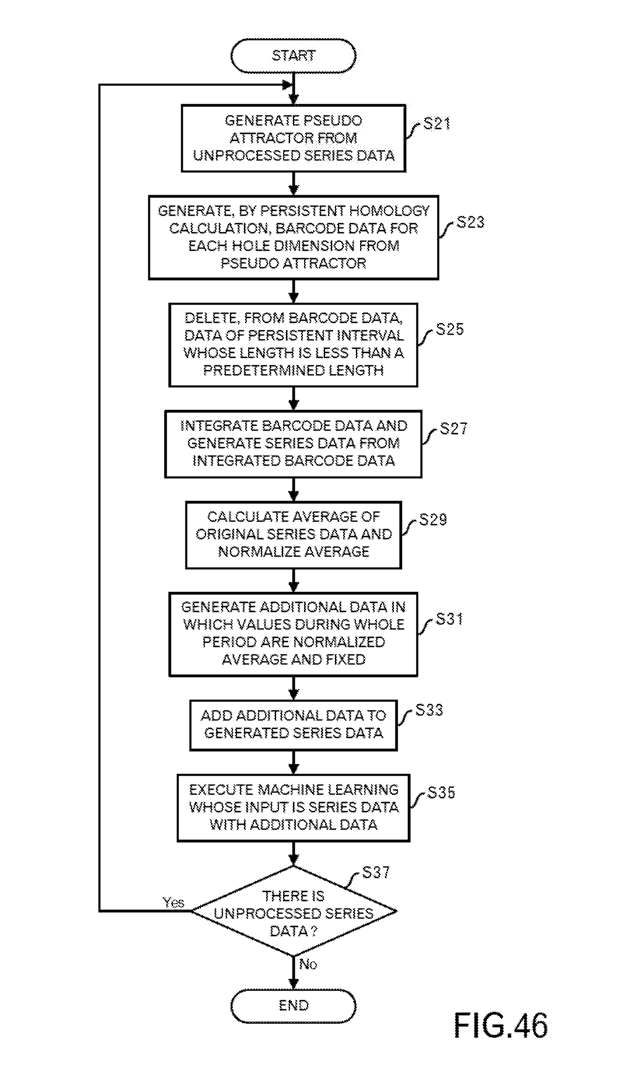

Next, operation of the information processing apparatus 1 will be explained using FIGS. 46 to 48.

First, the first generator 103 of the information processing apparatus 1 reads out unprocessed series data that is stored in the first series data storage unit 101. When there are plural sets of unprocessed series data stored in the first series data storage unit 101, series data of one unprocessed set is read out. Then, the first generator 103 generates a pseudo attractor from the read out series data according to Takens' embedding theorem (FIG.46: step S21), and stores the generated pseudo attractor in the pseudo attractor data storage unit 105. This processing is the same as the processing of step S1.

The second generator 107 reads out the pseudo attractor that was generated in step S21 from the pseudo attractor data storage unit 105. Then the second generator 107 generates barcode data from the pseudo attractor for each hole dimension by calculation processing of persistent homology (step S23). The second generator 107 stores the generated barcode data in the barcode data storage unit 109. This processing is the same as the processing of step S3.

When barcode data is stored in the barcode data storage unit 109, the removal unit 119 deletes, from the barcode data storage unit 109, data of persistent intervals that have a length that is less than a predetermined length (step S25). This processing is the same as the processing of step S5.

The third generator 111 reads out barcode data that is stored in the barcode data storage unit 109. Then, the third generator 111 integrates the read out barcode data, and generates series data from the integrated barcode data (step S27). The third generator 111 stores the generated series data in the second series data storage unit 113. This processing is the same as the processing of step S7.

The addition unit 121 reads out the series data that was read out in step S21 (hereinafter, referred to as the original series data) from the first series data storage unit 101. Then, the addition unit 121 calculates an average value of the values included in the original series data, and normalizes the calculated average value (step S29). The calculation and normalization of average value is well-known calculation, and thus a further explanation is not given here.

The addition unit 121 generates additional data in which values during a whole period are fixed by the average value normalized in step S29 (step S31). In other words, values at each time of the additional data are the same as the normalized average value in the whole period. Then, the addition unit 121 adds the additional data at the head of or at the tail of the series data that is stored in the second series data storage unit 113 (step S33).

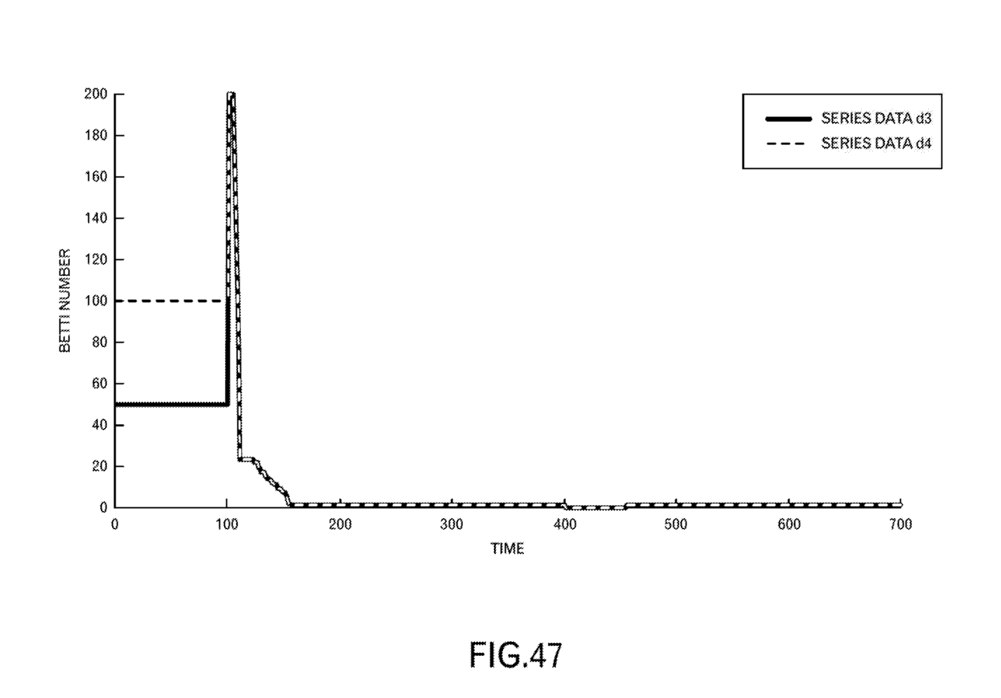

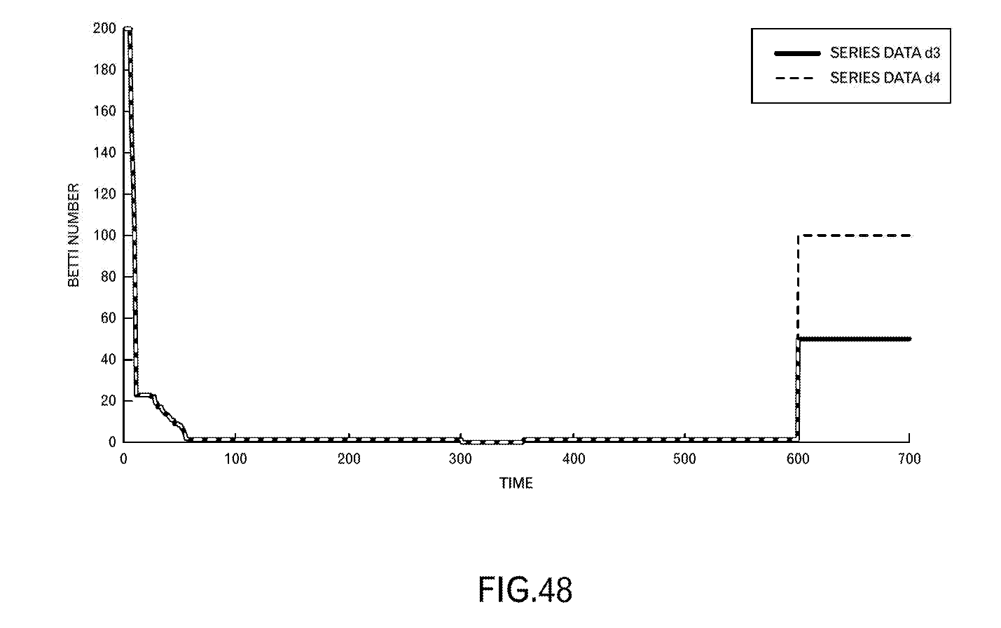

FIG. 47 and FIG. 48 are diagrams depicting examples of series data to which additional data has been added. In FIG. 47, the additional data is added at the head of the series data, where the vertical axis represents the Betti number and the horizontal axis represents the time. The additional data is data from time 0 to time 100, and the series data is data from time 100 to time 700. Moreover, in FIG. 48, the additional data is added at the tail of the series data, where the vertical axis represents the Betti number and the horizontal axis represents the time. The additional data is data from time 600 to time 700, and the series data is data from time 0 to time 600.

Returning to the explanation of FIG. 46, the machine learning unit 115 executes machine learning in which series data that is stored in the second series data storage unit 113 is used as input (step S35). The machine learning unit 115 stores a result of machine learning in the learning result storage unit 117. The result of machine learning includes a classification result of series data (in other words, output from machine learning), and may also include parameters used when calculating output from input. Moreover, as described above, machine learning of this embodiment may be supervised learning or unsupervised learning.

The machine learning unit 115 determines whether there is unprocessed series data (step S37). When there is unprocessed series data (step S37: YES route), the processing returns to step S21. When there is no unprocessed series data (step S37: NO route), the processing ends.

By executing processing such as described above, it is possible to distinguish different series data in machine learning even when translation and superimposing of series data are possible.

Although the embodiments of this invention were explained above, this invention is not limited to those. For example, the functional block configuration of the information processing apparatus 1, which is explained above, does not always correspond to actual program module configuration.

Moreover, the aforementioned data configuration is a mere example, and may be changed. Furthermore, as for the processing flow, as long as the processing results do not change, the turns of the steps may be exchanged or the steps may be executed in parallel.

In FIG. 15, barcode data is integrated in order of dimension 0, dimension 1, and dimension 2, however, order is not limited to this order.

The series data may also be data other than time series data (for example, a number sequence or a character string).

Moreover, in the second embodiment, it is also possible to use a set of series data and additional data as input for machine learning without adding the additional data to the series data. In other words, it is also possible to perform multiple input learning.

### APPENDIX

In this addendum, an explanation of matter related to these embodiments is added.

As for a time series having much oscillation, values with respect to time (in other words, vector element numbers) changes variously, and thus it is difficult to set a meaning for each element number. Therefore, for time series having much oscillation, a feature value was used such as explained in the column of background art.

However, when a target is a chaotic time series, these kinds of feature values may become a completely different value even for time series having the same rule of change. Chaos is a phenomenon in which different initial values produce results that appear to be completely different even though rules of change are the same. Such a characteristic of chaos is called initial value sensitivity, and commonly is also called a butterfly effect.

For example, assume that a time series changes according to the following rule.

x(i+1)=0.25·(tan h(−20·(x(i)−0.75))+tan h(−20·(x(i)−0.25)))+0.5

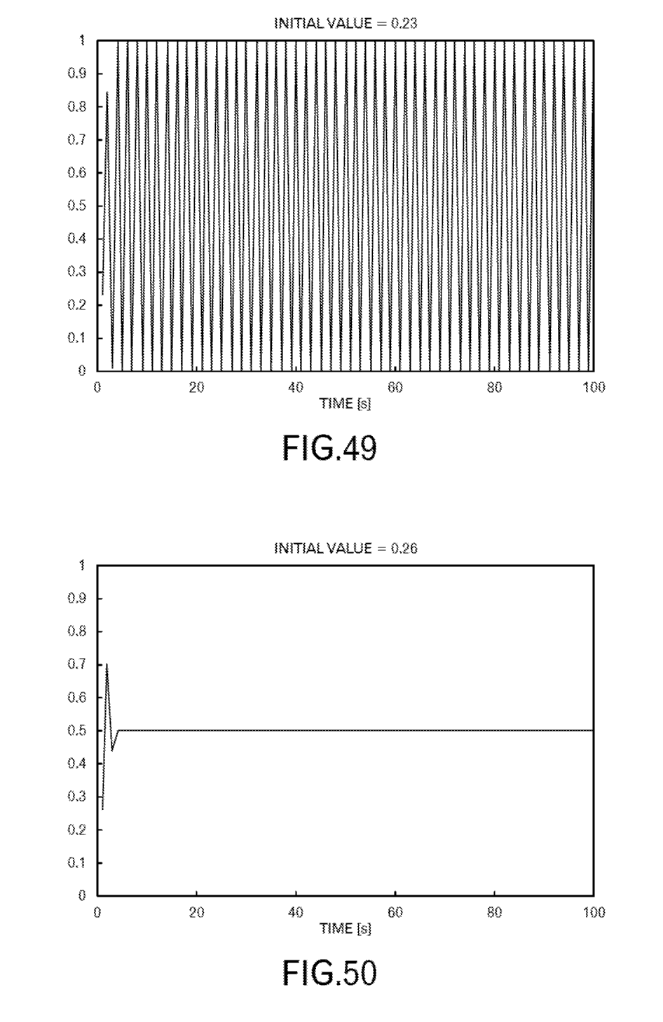

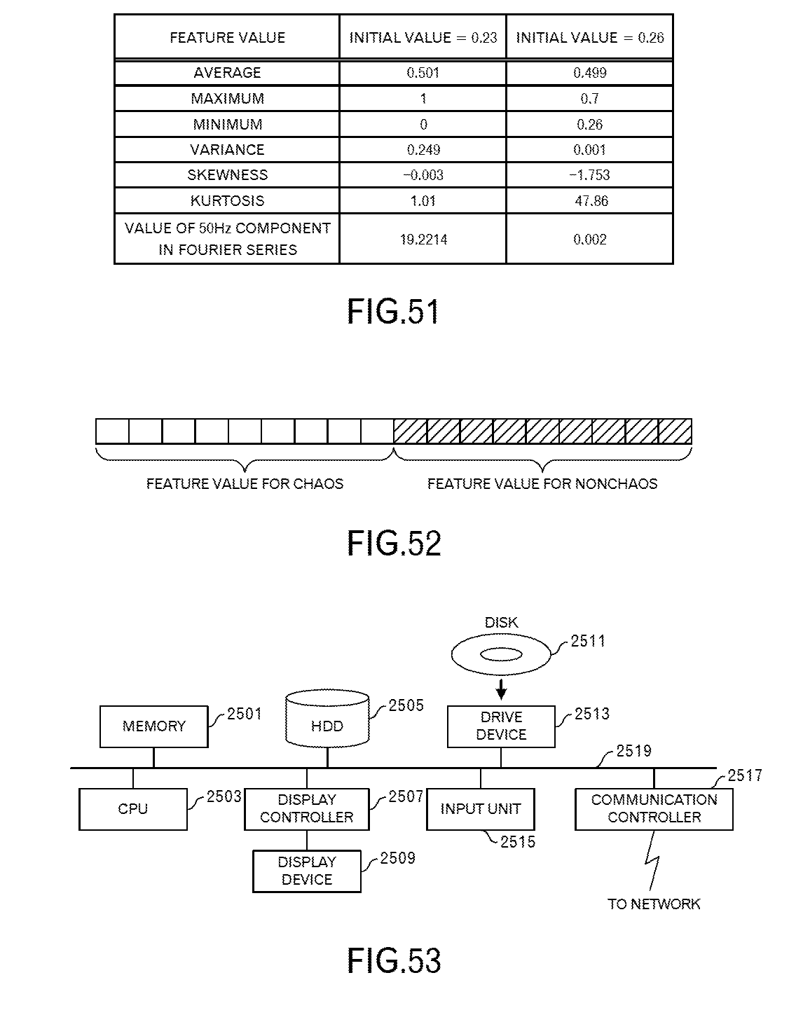

Here i is a variable that represents time. And when following this rule, when an initial value is 0.23 the value changes as illustrated in FIG. 49, and when an initial value is 0.26 the value changes as illustrated in FIG. 50. The feature value when using each of these initial values becomes a value as illustrated in FIG. 51. Therefore, it is not possible to perform classification of a time series according to its rule of change by the feature value such as described above.

A feature value of a dynamical system (for example, maximum Lyapunov exponent or the like) maybe used for a chaotic time series. However, a feature value of a dynamical system becomes the same value or becomes a meaningless value in all non-chaotic time series. Therefore, even when a feature value of a dynamical system is used, it is not possible to generate input for machine learning, which is able to handle a chaotic time series and non-chaotic time series at the same time.

For example, as illustrated in FIG. 52, generating a feature value in which a feature value for chaos and a feature value for non-chaos are arranged is also considered. This feature value is effective when classification is divided into a chaotic time series and a non-chaotic time series. However, often a difference between a chaotic time series and a non-chaotic time series is subtle. For example, in the case of time series having a rule x(i+1)=a*x(i)(1−x(i)), there is no chaos when a=3, however, there is chaos when a>3. Moreover, for example, in the classification of a person's behavior, there are cases in which a chaotic person and a non-chaotic person are included in the same classification. Therefore, in reality, a chaotic time series and a non-chaotic time series do not become completely different classifications, and a feature value such as described above is not effective.

On the other hand, by using the methods of the first embodiment and the second embodiment, it is possible to generate input for machine learning that is capable of handling both a chaotic time series and non-chaotic time series at the same time.

This appendix then ends.

In addition, the aforementioned information processing apparatus 1 is computer device as illustrated in FIG. 53. That is, a memory 2501 (storage device), a CPU 2503 (central processing unit) that is a hardware processor, a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 53. An operating system (OS) and an application program for carrying out the foregoing processing in the embodiment, are stored in the HDD 2505, and when executed by the

CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In these embodiments of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer device as stated above, the hardware such as the CPU 2503 and the memory 2501, the OS and the application programs systematically cooperate with each other, so that various functions as described above in details are realized.

The aforementioned embodiments are summarized as follows:

A machine learning method related to these embodiments includes: (A) first generating a pseudo attractor from each of plural series data sets, the pseudo attractor being a set of points in N-dimensional space, each of the points including N values sampled at an equal interval; (B) second generating a series data set of Betti numbers from each of plural pseudo attractors generated in the first generating by calculation of persistent homology, each of the Betti numbers being a number of holes for a radius of a N-dimensional sphere in the N-dimensional space; and (C) performing machine learning for each of plural series data sets of Betti numbers generated in the second generating, the series data set of Betti numbers being used as input in the machine learning.

By performing processing as described above, it becomes possible to convert a pseudo attractor to a format suitable for input of machine learning. And thus it becomes possible to classify a series data set by using a pseudo attractor generated from the series data set.

Moreover, the second generating may further include: (b1) third generating data of duration between birth and death of holes for each hole dimension by calculation of persistent homology; (b2) calculating the Betti numbers based on the data of duration for each hole dimension; and (b3) fourth generating the series data set of Betti numbers based on the Betti numbers calculated for each hole dimension. It becomes possible to classify with higher accuracy.

Moreover, each of the Betti numbers may be a number of holes whose difference between a radius at birth and a radius at death is a predetermined length or more. It becomes possible to remove an effect of noise.

Moreover, the machine learning method may further include: (D) calculating an average of values included in the series data set for each of the plural series data sets. And the performing may include (c1) performing the machine learning, the series data set of Betti numbers and the average being used as input in the machine learning. It becomes possible to classify properly even when handling series data that is able to be overlap by translation.

Moreover, each of the plural series data sets may be a labeled series data set, and (c2) the performing may include performing the machine learning for a relationship between the Betti numbers for the radius of the N-dimensional sphere and a label. It becomes possible to also handle supervised learning.

Moreover, the holes may be elements of a homology group.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable recording medium storing therein a learning program that causes a computer to execute a process comprising:
first generating a pseudo attractor from each of a plurality of series data sets, the pseudo attractor being a set of points in N-dimensional space, each of the points including N values sampled at an equal interval;
second generating a series data set of Betti numbers from each of a plurality of pseudo attractors generated in the first generating by calculation of persistent homology, each of the Betti numbers being a number of holes for a radius of a N-dimensional sphere in the N-dimensional space; and
performing machine learning for each of a plurality of series data sets of Betti numbers generated in the second generating, the series data set of Betti numbers being used as input in the machine learning.

2. The non-transitory computer-readable recording medium as set forth in claim 1, wherein the second generating comprises:
third generating data of duration between birth and death of holes for each hole dimension by the calculation of persistent homology;
calculating the Betti numbers based on the data of duration for each hole dimension; and
fourth generating the series data set of Betti numbers based on the Betti numbers calculated for each hole dimension.

3. The non-transitory computer-readable recording medium as set forth in claim 1, wherein each of the Betti numbers is a number of holes whose difference between a radius at birth and a radius at death is a predetermined length or more.

4. The non-transitory computer-readable recording medium as set forth in claim 1, further comprising:
calculating an average of values included in the series data set for each of the plurality of series data sets, and
wherein the performing comprises performing the machine learning, the series data set of Betti numbers and the average being used as input in the machine learning.

5. The non-transitory computer-readable recording medium as set forth in claim 1, wherein each of the plurality of series data sets is a labeled series data set, and the performing comprises performing the machine learning for a relationship between the Betti numbers for the radius of the N-dimensional sphere and a label.

6. The non-transitory computer-readable recording medium as set forth in claim 1, wherein the holes are elements of a homology group.

7. A machine learning method comprising:
first generating, by using a computer, a pseudo attractor from each of a plurality of series data sets, the pseudo attractor being a set of points in N-dimensional space, each of the points including N values sampled at an equal interval;
second generating, by using the computer, a series data set of Betti numbers from each of a plurality of pseudo attractors generated in the first generating by calculation of persistent homology, each of the Betti numbers being a number of holes for a radius of a N-dimensional sphere in the N-dimensional space; and
performing, by using the computer, machine learning for each of a plurality of series data sets of Betti numbers generated in the second generating, the series data set of Betti numbers being used as input in the machine learning.

8. An information processing apparatus, comprising:
a memory; and
a processor coupled to the memory and configured to:
first generate a pseudo attractor from each of a plurality of series data sets, the pseudo attractor being a set of points in N-dimensional space, each of the points including N values sampled at an equal interval;
second generate a series data set of Betti numbers from each of a plurality of pseudo attractors generated in the first generating by calculation of persistent homology, each of the Betti numbers being a number of holes for a radius of a N-dimensional sphere in the N-dimensional space; and
perform machine learning for each of a plurality of series data sets of Betti numbers generated in the second generating, the series data set of Betti numbers being used as input in the machine learning.
